(19) United States
(12) Patent Application Publication
(10) Pub. No.: US 2011/0064648 A1
(43) Pub. Date: Mar. 17, 2011

(54) TWO-MODE PROCESS FOR HYDROGEN PRODUCTION

(75) Inventors: William E. Preston, Sugar Land, TX (US); Avinash Sirdeshpande, Houston, TX (US)

(73) Assignee: GREATPOINT ENERGY, INC., Cambridge, MA (US)

(21) Appl. No.: 12/882,417

(22) Filed: Sep. 15, 2010

Related U.S. Application Data
(60) Provisional application No. 61/242,894, filed on Sep. 16, 2009.

(51) Int. Cl. C01B 3/32

(52) U.S. Cl. 423/648.1

(57) ABSTRACT

The present invention relates to a 2-mode processes for preparing gaseous products, and in particular a hydrogen product stream, via the hydromethanation of carbonaceous feedstocks in the presence of steam, carbon monoxide, hydrogen and a hydromethanation catalyst in a first mode, and a partial oxidation of methane in a second mode.

### CROSS REFERENCE TO RELATED APPLICATION

This application claims priority under 35 U.S.C. §119 from U.S. Provisional Application Ser. No. 61/242,894 (filed 16 Sep. 2009), the disclosure of which is incorporated by reference herein for all purposes as if fully set forth.

This application is related to commonly-owned U.S. patent application Ser. No. 12/778,548 (attorney docket no. FN-0048 US NP1, entitled PROCESSES FOR HYDROMETHANATION OF A CARBONACEOUS FEEDSTOCK, filed 12 May 2010) and Ser. No. 12/851,864 (attorney docket no. FN-0050 US NP1, entitled PROCESSES FOR HYDROMETHANATION OF A CARBONACEOUS FEEDSTOCK, filed 6 Aug. 2010).

### FIELD OF THE INVENTION

The present invention relates to a 2-mode processes for preparing gaseous products, and in particular a hydrogen product stream, via the hydromethanation of carbonaceous feedstocks in the presence of steam, carbon monoxide, hydrogen and a hydromethanation catalyst in a first mode, and a partial oxidation of methane in a second mode.

### BACKGROUND OF THE INVENTION

In view of numerous factors such as higher energy prices and environmental concerns, the production of value-added gaseous products from lower-fuel-value carbonaceous feedstocks, such as petroleum coke, coal and biomass, is receiving renewed attention. The catalytic gasification of such materials to produce methane and other value-added gases is disclosed, for example, in U.S. Pat. No. 3,828,474, U.S. Pat. No. 3,998,607, U.S. Pat. No. 4,057,512, U.S. Pat. No. 4,092,125, U.S. Pat. No. 4,094,650, U.S. Pat. No. 4,204,843, U.S. Pat. No. 4,468,231, U.S. Pat. No. 4,500,323, U.S. Pat. No. 4,541,841, U.S. Pat. No. 4,551,155, U.S. Pat. No. 4,558,027, U.S. Pat. No. 4,606,105, U.S. Pat. No. 4,617,027, U.S. Pat. No. 4,609,456, U.S. Pat. No. 5,017,282, U.S. Pat. No. 5,055,181, U.S. Pat. No. 6,187,465, U.S. Pat. No. 6,790,430, U.S. Pat. No. 6,894,183, U.S. Pat. No. 6,955,695, US2003/0167961A1, US2006/0265953A1, US2007/000177A1, US2007/083072A1, US2007/0277437A1, US2009/0048476A1, US2009/0090056A1, US2009/0090055A1, US2009/0165383A1, US2009/0166588A1, US2009/0165379A1, US2009/0170968A1, US2009/0165380A1, US2009/0165381A1, US2009/0165361A1, US2009/0165382A1, US2009/0169449A1, US2009/0169448A1, US2009/0165376A1, US2009/0165384A1, US2009/0217584A1, US2009/0217585A1, US2009/0217590A1, US2009/0217586A1, US2009/0217588A1, US2009/0217589A1, US2009/0217575A1, US2009/0217587A1 and GB1599932.

In general, carbonaceous materials, such as coal, biomass, asphaltenes, liquid petroleum residues and/or petroleum coke, can be converted to a plurality of gases, including value-added gases such as methane, by the reaction of the material in the presence of a catalyst source and steam at elevated temperatures and pressures. The raw gases are cooled and scrubbed in multiple processes to remove side-products such as hydrogen and carbon monoxide, and undesirable contaminants including carbon dioxide and hydrogen sulfide, to produce a methane product stream.

The hydromethanation of a carbon source to methane typically involves four separate reactions:

Steam carbon: C+H₂O→CO+H₂ (I)

Water-gas shift: CO+H₂O→H₂+CO₂ (II)

CO Methanation: CO+3H₂→CH₄+H₂O (III)

Hydro-gasification: 2H₂+C→CH₄ (IV)

In the hydromethanation reaction, the first three reactions (I-III) predominate to result in the following overall reaction:

2C+2H₂O→CH₄+CO₂ (V).

The overall reaction is essentially thermally balanced; however, due to process heat losses and other energy requirements (such as required for evaporation of moisture entering the reactor with the feedstock), some heat must be added to maintain the thermal balance.

The reactions are also essentially syngas (hydrogen and carbon monoxide) balanced (syngas is produced and consumed); therefore, as carbon monoxide and hydrogen are withdrawn with the product gases, carbon monoxide and hydrogen need to be added to the reaction as required to avoid a deficiency.

In order to maintain the net heat of reaction as close to neutral as possible (only slightly exothermic or endothermic), and maintain the syngas balance, a superheated gas stream of steam, carbon monoxide and hydrogen is often fed to the hydromethanation reactor. Frequently, the carbon monoxide and hydrogen streams are recycle streams separated from the product gas, and/or are provided by reforming a portion of the product methane. See, for example, U.S. Pat. No. 4,094,650, U.S. Pat. No. 6,955,595 and US2007/083072A1.

The separation of the recycle gases from the methane product, for example by cryogenic distillation, and the reforming of the methane product, greatly increase the engineering complexity and overall cost of producing methane, and decrease the overall system efficiency.

Steam generation is another area that can increase the engineering complexity of the overall system. The use of externally fired boilers, for example, can greatly decrease overall system efficiency.

An improved hydromethanation process where gas recycle loops are eliminated or improved, and steam is generated efficiently, to decrease the complexity and cost of producing methane, is described in US2009/0165376A1, US2010/0120926A1, US2010/0071262A1, US2010/0076235A1 and US2010/0179232A1, as well as commonly owned and co-pending U.S. patent application Ser. No. 12/778,538 (attorney docket no. FN-0047 US NP1, entitled PROCESSES FOR HYDROMETHANATION OF A CARBONACEOUS FEEDSTOCK), Ser. No. 12/778,548 (attorney docket no. FN-0048 US NP1, entitled PROCESSES FOR HYDROMETHANATION OF A CARBONACEOUS FEEDSTOCK) and Ser. No. 12/778,552 (attorney docket no. FN-0049 US NP1, entitled PROCESSES FOR HYDROMETHANATION OF A CARBONACEOUS FEEDSTOCK), each of which was filed 12 May 2010.

In the hydromethanation reaction, as indicated above, the result is a “direct” methane-enriched raw product gas stream, which can be subsequently purified and further methane-enriched to provide a final methane product. This is distinct from conventional gasification processes, such as those based on partial combustion/oxidation of a carbon source, where a syngas (carbon monoxide+hydrogen) is the primary product (little or no methane is directly produced), which can then be further processed to produce methane (via catalytic methanation, see reaction (III)) or any number of other higher hydrocarbon products.

Since hydrogen is a syngas component of conventional gasification processes, these processes can also be adapted for hydrogen production.

When methane is the desired end-product, the hydromethanation reaction provides the possibility for increased efficiency and lower methane cost than traditional gasification processes.

While hydrogen is a potential side-product of the aforementioned hydromethanation processes, such as for example disclosed in US2009/0259080A1 and previously incorporated U.S. patent application Ser. No. 12/778,548 (attorney docket no. FN-0048 US NP1, entitled PROCESSES FOR HYDROMETHANATION OF A CARBONACEOUS FEEDSTOCK, filed 12 May 2010), it may be desirable to produce hydrogen as a primary product, with some (or no) methane as a by-product, while retaining the efficiency and other benefits of the hydromethanation process versus traditional gasification processes. Commonly-owned U.S. patent application Ser. No. 12/851,864 (attorney docket no. FN-0050 US NP1, entitled PROCESSES FOR HYDROMETHANATION OF A CARBONACEOUS FEEDSTOCK, filed 6 Aug. 2010) provides such a hydrogen-production process.

In the context of hydrogen supply, it would be desirable to insure the continuity of hydrogen supply even if the hydromethanation portion of the process disclosed in previously incorporated U.S. patent application Ser. No. 12/851,864 is not operating, for example, during maintenance or other shutdown periods. The present invention provides such a process.

### SUMMARY OF THE INVENTION

In one aspect, the invention provides a process for generating a hydrogen product stream, the process comprising a first hydrogen production mode and a second hydrogen production mode, wherein the second hydrogen production mode is utilized when the first hydrogen production mode is not operating, wherein the first hydrogen production mode comprises the steps of:

(a) supplying to a hydromethanation reactor (1) a carbonaceous feedstock, (2) a hydromethanation catalyst, (3) a steam stream, (4) a feed gas stream and (5) optionally a first oxygen-rich gas stream;

(b) reacting the carbonaceous feedstock in the hydromethanation reactor in the presence of carbon monoxide, hydrogen, steam, hydromethanation catalyst and optionally oxygen, to produce a methane-enriched raw product stream comprising methane, carbon monoxide, hydrogen, carbon dioxide, hydrogen sulfide and heat energy;

(c) withdrawing the methane-enriched raw product stream from the hydromethanation reactor;

(d) introducing the methane-enriched raw product stream into a first heat exchanger unit to remove heat energy from the methane-enriched raw product stream;

(e) sour shifting at least a predominant portion of the carbon monoxide in the methane-enriched raw product stream in a sour shift unit to produce a hydrogen-enriched raw product stream comprising hydrogen, methane, carbon dioxide, hydrogen sulfide and optionally carbon monoxide;

(f) removing a substantial portion of the carbon dioxide and a substantial portion of the hydrogen sulfide from the hydrogen-enriched raw product stream in an acid gas removal unit to produce a sweetened gas stream comprising a substantial portion of the hydrogen, methane and carbon monoxide (if present) from the hydrogen-enriched raw product stream;

(g) separating at least a predominant portion of the hydrogen from the sweetened gas stream in a hydrogen separation unit to produce (1) the hydrogen product stream and (2) a hydrogen-depleted sweetened gas stream comprising methane, carbon monoxide (if present in the sweetened gas stream) and optionally hydrogen;

(h) optionally splitting the hydrogen-depleted sweetened gas stream into a recycle gas stream and a methane-rich product gas stream;

(i) supplying at least a portion of the hydrogen-depleted sweetened gas stream (or the recycle gas stream if present), a second oxygen-rich gas stream and an optional supplemental methane gas stream to a partial oxidation reactor; and

(j) reacting the supplied hydrogen-depleted sweetened gas stream (or the supplied recycle gas stream if present) and the supplied supplemental methane gas stream (if present) with oxygen in the partial oxidation reactor to generate heat energy and the feed gas stream, wherein the feed gas steam comprises carbon monoxide, hydrogen and steam,

wherein the reaction in step (b) has a syngas demand, and the amount of the hydrogen-depleted sweetened gas stream (or the recycle gas stream if present) supplied to the partial oxidation reactor is at least sufficient to generate enough carbon monoxide and hydrogen in the feed gas stream to at least meet the syngas demand of the reaction in step (b); and

wherein the second hydrogen production mode comprises the steps of:

(1) supplying the supplemental methane gas stream and the second oxygen-rich gas stream to the partial oxidation reactor;

(2) reacting the supplied supplemental methane gas stream with oxygen in the partial oxidation reactor to generate heat energy and a supplemental gas stream comprising carbon monoxide, hydrogen and steam;

(3) introducing the supplemental gas stream into a heat exchanger unit to remove heat energy from the supplemental gas stream;

(4) sour shifting at least a substantial portion of the carbon monoxide in the supplemental gas stream in a sour shift unit to produce a hydrogen-enriched supplemental gas stream comprising hydrogen and carbon dioxide;

(5) removing a substantial portion of the carbon dioxide from the hydrogen-enriched supplemental gas stream in an acid gas unit to produce a hydrogen gas stream comprising a substantial portion of the hydrogen from the hydrogen-enriched supplemental gas stream; and

(6) purifying the hydrogen gas stream in a hydrogen separation unit to produce the hydrogen product stream.

The process in accordance with the present invention is useful, for example, for producing hydrogen from various carbonaceous feedstocks. When the hydromethanation portion of the process is operating, the process is also optionally useful for producing a methane by-product stream, specifically one that is a “pipeline-quality natural gas”.

Particularly, the process is configured to be able to substantially continuously provide a hydrogen product stream even in the event, for example, that the hydromethanation portion of the process (first hydrogen production mode) is not being utilized, for example, due to maintenance or other operation issues.

In one embodiment of the hydromethanation portion of the process, the feed gas stream from the partial oxidation reactor is introduced into a second heat exchanger unit to remove heat energy from the feed gas stream prior to supplying the feed gas stream to the hydromethanation reactor.

When the hydromethanation portion of the process is not operating, and the second hydrogen production mode is running, the partial oxidation reactor used for steps (i) and (j) is used for steps (1) and (2), a sour shift unit used for step (e) can be used for step (4), an acid gas removal unit (and particularly the CO₂ removal portion) used for step (f) can be used for step (5), a hydrogen separation unit used for step (g) can be used for step (6), and the first and/or second heat exchanger units can be utilized for step (3). Stated another way, the heat exchanger unit used in the second hydrogen production mode can also be used in the first hydrogen production mode; the sour shift unit used in the second hydrogen production mode can also be used in the first hydrogen production mode; the acid gas removal unit used in the second hydrogen production mode can also used in the first hydrogen production mode; and/or the hydrogen separation unit used in the second hydrogen production mode can also be used in the first hydrogen production mode.

The second hydrogen production mode, therefore, can be performed without additional equipment or operational complexity.

In one embodiment, the first hydrogen production mode is operating. In another embodiment, the first hydrogen production is not operating, and the second hydrogen production mode is operating.

In one embodiment hydromethanation portion of the process, step (h) is present. In such a case, if the methane-rich product gas stream comprises carbon monoxide, the carbon monoxide is optionally reacted with hydrogen in the methane-rich product gas stream in the presence of a methanation catalyst to produce a methane-enriched product gas stream. If the amount of hydrogen in the methane-rich product gas stream is insufficient to react with substantially all of the carbon monoxide present, a portion of the sweetened gas stream can be split off to bypass the hydrogen separation step and recombined with the methane-rich product gas stream to supply the necessary hydrogen. Alternatively, a portion of the hydrogen product stream can be recombined with the methane-rich product gas stream to supply the necessary hydrogen.

When a catalytic methanation step is present (the methane-rich product gas stream is catalytically methanated), the resulting methane-enriched product gas stream is optionally introduced into a third heat exchanger unit to remove heat energy from the methane-enriched product gas stream.

Desirably, the methane-rich product gas stream (or the methane-enriched product gas stream if present) is a pipeline-quality natural gas.

In another embodiment of the hydromethanation portion of the process, step (h) is not present and at least substantial portion of the hydrogen-depleted sweetened gas stream is supplied to the partial oxidation reactor.

In one embodiment of the process, the hydrogen-enriched raw product stream from step (e) (or the hydrogen-enriched supplemental gas stream from step (4)) (from a sour shift unit), is introduced into a fourth heat exchanger unit to remove heat energy from the hydrogen-enriched raw product stream (or the hydrogen-enriched supplemental gas stream) prior to supplying the hydrogen-enriched raw product stream (or the hydrogen-enriched supplemental gas stream) to step (f) (or step (5)) (an acid gas removal unit).

In another embodiment, the heat energy removed in the first, second (if present), third (if present) and fourth (if present) heat exchanger units is recovered through the generation of one or more process steam streams, and/or through the heating/superheating of one or more process streams. For example, the heat energy recovered in the first heat exchanger unit can be used to superheat the steam stream prior to introduction into the hydromethanation reactor, and/or generate a first process steam stream; the heat energy recovered in the second heat exchanger unit (if present) can be used to generate a second process steam stream, and/or superheat the second or another process steam stream; the heat energy recovered in the third heat exchanger unit (if present) can be used to generate a third process steam stream; and the heat energy recovered in the fourth heat exchanger unit (if present) can be used to preheat boiler feed water used to generate process steam in, for example, one or more of the first, second and third heat exchanger units, and/or superheat the cooled methane-enriched raw product stream prior to introduction into step (e) (into a sour shift unit).

Desirably, the steam stream is substantially made up from at least a portion of one or more of the process steam streams generated from process heat recovery in the first, second (if present) and third (if present) heat exchanger units.

In another embodiment of the hydromethanation portion of the process, the reaction in step (b) has a steam demand, a syngas demand and a heat demand.

In one embodiment with regard to the steam demand, (1) the carbonaceous feedstock optionally comprises a moisture content, (2) the first oxygen-rich gas stream, if present, optionally comprises steam, and (3) the steam demand is substantially satisfied by the steam stream, steam contained in the feed gas stream, the moisture content (if present) of the carbonaceous feedstock, and (if present) steam in the first oxygen-rich gas stream.

In one embodiment with regard to the heat demand, the steam stream and the feed gas stream as fed into the hydromethanation reactor comprise heat energy that, in combination, is sufficient to at least meet the heat demand of the reaction in step (b).

In one embodiment with regard to the syngas demand, the amount of carbon monoxide and hydrogen generated in the POx reactor are in excess of the syngas demand of the hydromethanation reaction, and a portion of the feed gas stream is split and combined with the methane-enriched raw product gas stream prior to step (e).

Another specific embodiment is one in which the hydromethanation portion of the process, when operating, is a continuous process, in which steps (a), (b), (c), (d), (e), (f), (g), (i), (j) and (k), and when present (h), are operated in a continuous manner.

Another specific embodiment is one in which the second hydrogen production mode, when operating, is a continuous process, in which steps (1), (2), (3), (4), (5) and (6) above are operated in a continuous manner.

Another specific embodiment of the hydromethanation portion of the process is one in which the first oxygen-rich gas stream is supplied periodically or continuously to the hydromethanation reactor. The amount of oxygen provided can be varied as a process control, for example, to assist control of the temperature in the hydromethanation reactor. As oxygen is supplied to the hydromethanation reactor, carbon from the feedstock (for example in the by-product char) is partially oxidized/combusted to generate heat energy (as well as some amounts of carbon monoxide and hydrogen). The amount of oxygen supplied to the hydromethanation reactor can be increased or decreased to increase the amount of carbon being consumed and, consequently, the amount of heat energy being generated in situ in the hydromethanation reactor. In such a case, this heat energy generated in situ reduces the heat demand of the reaction in step (b), and thus the amount of heat energy supplied in the steam stream and the feed gas stream to meet the heat demand.

Another specific embodiment of the hydromethanation portion of the process is one in which the first oxygen-rich gas stream is supplied periodically or continuously to the hydromethanation reactor, the first oxygen-rich gas stream comprises steam, and the steam in the first oxygen-rich gas stream is substantially made up from at least a portion of one or more of the process steam streams.

Another specific embodiment of the hydromethanation portion of the process is one in which a superheater is present to superheat the feed gas stream, steam stream or both prior to supply to the hydromethanation reactor, and the superheater is fired from a portion of the hydrogen-depleted sweetened gas stream (or methane-rich gas product stream if present, or the recycle gas stream if present, or methane-enriched product gas stream if present).

Another specific embodiment of the hydromethanation portion of the process is one in which the steam stream and the feed gas stream are combined prior to being supplied to the hydromethanation reactor.

Another specific embodiment of the hydromethanation portion of the process is one in which a char by-product is generated in step (b), wherein the char by-product is periodically or continuously withdrawn from the hydromethanation reactor, and at least a portion of the withdrawn by-product char is provided to a catalyst recovery operation. Recovered catalyst is then recycled and combined with makeup catalyst to meet the demands of the hydromethanation reaction.

Another specific embodiment of the hydromethanation portion of the process is one in which a char by-product is generated in step (b), the hydromethanation reactor comprises a collection zone where the char by-product collects, the first oxygen-rich gas stream is supplied to the hydromethanation reactor, and the first oxygen-rich gas stream is introduced into the char by-product collection zone of the hydromethanation reactor. As the by-product char comprises carbon content from the carbonaceous feedstock, the char carbon is desirably preferentially consumed to generate heat energy (and some amounts of carbon monoxide and hydrogen).

Another specific embodiment of the hydromethanation portion of the process is one in which the process steam streams from the first, second (when present) and third (when present) heat exchanger units are generated at a pressure higher than the pressure in the hydromethanation reactor. The pressure of the process steam streams (and ultimate steam stream) should be high enough above the pressure in the hydromethanation reactor such that no additional compression is necessary.

These and other embodiments, features and advantages of the present invention will be more readily understood by those of ordinary skill in the art from a reading of the following detailed description.

### BRIEF DESCRIPTION OF THE DRAWINGS

FIG. 1 is a diagram of an embodiment of a hydromethanation portion of the process in accordance with the present invention whereby a hydrogen product stream and an optional methane product stream is produced from a carbonaceous feedstock.

FIG. 2 is a diagram of the front-end portion of the hydromethanation portion of the process where a methane-enriched raw product stream is produced.

FIG. 3 is a diagram of a process for the further processing of a methane-enriched raw product stream to generate a hydrogen product stream and an optional methane product stream.

FIG. 4 is a diagram of a process for the second production mode of the hydrogen product stream.

### DETAILED DESCRIPTION

The present disclosure relates to processes to generate a hydrogen product stream, the processes comprising two operating modes.

The first mode, among other steps, includes providing a carbonaceous feedstock, a hydromethanation catalyst, a syngas feed stream and a steam stream to a hydromethanation reactor to convert the carbonaceous feedstock in the presence of hydromethanation catalyst, carbon monoxide, hydrogen and steam into the plurality of gaseous products. The syngas feed stream is supplied by a partial oxidation (POx) reactor which consumes at least portion of the methane output of the hydromethanation reaction for syngas and heat generation. The plurality of gaseous products is then treated to ultimately result in a hydrogen product stream, and optionally a methane product stream as well. The methane product stream if present is desirably of sufficient purity to qualify as “pipeline-quality natural gas”.

The second mode, among other steps, includes providing a supplemental methane feed to the POx reactor to generate a syngas stream, then treating the syngas stream to ultimately result in the hydrogen product stream. The second mode is particularly useful as a backup hydrogen production process to insure substantially continuous hydrogen supply in the event that the hydromethanation portion of the process is not operating.

The present invention can be practiced in conjunction with the subject matter disclosed in commonly-owned US2007/0000177A1, US2007/0083072A1, US2007/0277437A1, US2009/0048476A1, US2009/0090056A1, US2009/0090055A1, US2009/0165383A1, US2009/0166588A1, US2009/0165379A1, US2009/0170968A1, US2009/0165380A1, US2009/0165381A1, US2009/0165361A1, US2009/0165382A1, US2009/0169449A1, US2009/0169448A1, US2009/0165376A1, US2009/0165384A1, US2009/0217582A1, US2009/0220406A1, US2009/0217590A1, US2009/0217586A1, US2009/0217588A1, US2009/0218424A1, US2009/0217589A1, US2009/0217575A1, US2009/0217587A1, US2009/0260287A1, US2009/0229182A1, US2009/0259080A1, US2009/0246120A1, US2009/0324458A1, US2009/0324459A1, US2009/0324460A1, US2009/0324461A1, US2009/0324462A1, US2010/0121125A1, US2010/0076235A1, US2010/0168495A1 and US2010/0168494A1.

Further, the present invention can be practiced in conjunction with the subject matter disclosed in commonly-owned U.S. patent application Ser. No. 12/778,548 (attorney docket no. FN-0048 US NP1, entitled PROCESSES FOR HYDROMETHANATION OF A CARBONACEOUS FEED-STOCK, filed 12 May 2010); and Ser. No. 12/851,864 (attorney docket no. FN-0050 US NP1, entitled PROCESSES FOR HYDROMETHANATION OF A CARBONACEOUS FEEDSTOCK, filed 6 Aug. 2010).

All publications, patent applications, patents and other references mentioned herein, including but not limited to those referenced above, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Although methods and materials similar or equivalent to those described herein can be used in the practice or testing of the present disclosure, suitable methods and materials are described herein.

Unless stated otherwise, all percentages, parts, ratios, etc., are by weight.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “substantial portion”, as used herein, unless otherwise defined herein, means that greater than about 90% of the referenced material, preferably greater than about 95% of the referenced material, and more preferably greater than about 97% of the referenced material. The percent is on a molar basis when reference is made to a molecule (such as methane, carbon dioxide, carbon monoxide and hydrogen sulfide), and otherwise is on a weight basis (such as for entrained carbonaceous fines).

The term “predominant portion”, as used herein, unless otherwise defined herein, means that greater than about 50% of the referenced material. The percent is on a molar basis when reference is made to a molecule (such as hydrogen, methane, carbon dioxide, carbon monoxide and hydrogen sulfide), and otherwise is on a weight basis (such as for entrained carbonaceous fines).

The term “carbonaceous material” as used herein can be, for example, biomass and non-biomass materials as defined herein.

The term “biomass” as used herein refers to carbonaceous materials derived from recently (for example, within the past 100 years) living organisms, including plant-based biomass and animal-based biomass. For clarification, biomass does not include fossil-based carbonaceous materials, such as coal. For example, see previously incorporated US2009/0217575A1 and US2009/0217587A1.

The term “plant-based biomass” as used herein means materials derived from green plants, crops, algae, and trees, such as, but not limited to, sweet sorghum, bagasse, sugarcane, bamboo, hybrid poplar, hybrid willow, albizia trees, eucalyptus, alfalfa, clover, oil palm, switchgrass, sudangrass, millet, jatropha, and miscanthus (e.g., Miscanthus×giganteus). Biomass further include wastes from agricultural cultivation, processing, and/or degradation such as corn cobs and husks, corn stover, straw, nut shells, vegetable oils, canola oil, rapeseed oil, biodiesels, tree bark, wood chips, sawdust, and yard wastes.

The term “animal-based biomass” as used herein means wastes generated from animal cultivation and/or utilization. For example, biomass includes, but is not limited to, wastes from livestock cultivation and processing such as animal manure, guano, poultry litter, animal fats, and municipal solid wastes (e.g., sewage).

The term “non-biomass”, as used herein, means those carbonaceous materials which are not encompassed by the term “biomass” as defined herein. For example, non-biomass include, but is not limited to, anthracite, bituminous coal, sub-bituminous coal, lignite, petroleum coke, asphaltenes, liquid petroleum residues or mixtures thereof. For example, see previously incorporated US2009/0166588A1, US2009/0165379A1, US2009/0165380A1, US2009/0165361A1, US2009/0217590A1 and US2009/0217586A1.

The terms “petroleum coke” and “petcoke” as used here include both (i) the solid thermal decomposition product of high-boiling hydrocarbon fractions obtained in petroleum processing (heavy residues—“resid petcoke”); and (ii) the solid thermal decomposition product of processing tar sands (bituminous sands or oil sands—“tar sands petcoke”). Such carbonization products include, for example, green, calcined, needle and fluidized bed petcoke.

Resid petcoke can also be derived from a crude oil, for example, by coking processes used for upgrading heavy-gravity residual crude oil, which petcoke contains ash as a minor component, typically about 1.0 wt % or less, and more typically about 0.5 wt % of less, based on the weight of the coke. Typically, the ash in such lower-ash cokes comprises metals such as nickel and vanadium.

Tar sands petcoke can be derived from an oil sand, for example, by coking processes used for upgrading oil sand. Tar sands petcoke contains ash as a minor component, typically in the range of about 2 wt % to about 12 wt %, and more typically in the range of about 4 wt % to about 12 wt %, based on the overall weight of the tar sands petcoke. Typically, the ash in such higher-ash cokes comprises materials such as silica and/or alumina.

Petroleum coke has an inherently low moisture content, typically, in the range of from about 0.2 to about 2 wt % (based on total petroleum coke weight); it also typically has a very low water soaking capacity to allow for conventional catalyst impregnation methods. The resulting particulate compositions contain, for example, a lower average moisture content which increases the efficiency of downstream drying operation versus conventional drying operations.

The petroleum coke can comprise at least about 70 wt % carbon, at least about 80 wt % carbon, or at least about 90 wt % carbon, based on the total weight of the petroleum coke. Typically, the petroleum coke comprises less than about 20 wt % inorganic compounds, based on the weight of the petroleum coke.

The term “asphaltene” as used herein is an aromatic carbonaceous solid at room temperature, and can be derived, for example, from the processing of crude oil and crude oil tar sands.

The term “coal” as used herein means peat, lignite, sub-bituminous coal, bituminous coal, anthracite, or mixtures thereof. In certain embodiments, the coal has a carbon content of less than about 85%, or less than about 80%, or less than about 75%, or less than about 70%, or less than about 65%, or less than about 60%, or less than about 55%, or less than about 50% by weight, based on the total coal weight. In other embodiments, the coal has a carbon content ranging up to about 85%, or up to about 80%, or up to about 75% by weight, based on the total coal weight. Examples of useful coal include, but are not limited to, Illinois #6, Pittsburgh #8, Beulah (ND), Utah Blind Canyon, and Powder River Basin (PRB) coals. Anthracite, bituminous coal, sub-bituminous coal, and lignite coal may contain about 10 wt %, from about 5 to about 7 wt %, from about 4 to about 8 wt %, and from about 9 to about 11 wt %, ash by total weight of the coal on a dry basis, respectively. However, the ash content of any particular coal source will depend on the rank and source of the coal, as is familiar to those skilled in the art. See, for example, “Coal Data: A Reference”, Energy Information Administration, Office of Coal, Nuclear, Electric and Alternate Fuels, U.S. Department of Energy, DOE/EIA-0064(93), February 1995.

The ash produced from combustion of a coal typically comprises both a fly ash and a bottom ash, as are familiar to those skilled in the art. The fly ash from a bituminous coal can comprise from about 20 to about 60 wt % silica and from about 5 to about 35 wt % alumina, based on the total weight of the fly ash. The fly ash from a sub-bituminous coal can comprise from about 40 to about 60 wt % silica and from about 20 to about 30 wt % alumina, based on the total weight of the fly ash. The fly ash from a lignite coal can comprise from about 15 to about 45 wt % silica and from about 20 to about 25 wt % alumina, based on the total weight of the fly ash. See, for example, Meyers, et al. “Fly Ash. A Highway Construction Material,” Federal Highway Administration, Report No. FHWA-IP-76-16, Washington, D.C., 1976.

The bottom ash from a bituminous coal can comprise from about 40 to about 60 wt % silica and from about 20 to about 30 wt % alumina, based on the total weight of the bottom ash. The bottom ash from a sub-bituminous coal can comprise from about 40 to about 50 wt % silica and from about 15 to about 25 wt % alumina, based on the total weight of the bottom ash. The bottom ash from a lignite coal can comprise from about 30 to about 80 wt % silica and from about 10 to about 20 wt % alumina, based on the total weight of the bottom ash. See, for example, Moulton, Lyle K. “Bottom Ash and Boiler Slag,” Proceedings of the Third International Ash Utilization Symposium, U.S. Bureau of Mines, Information Circular No. 8640, Washington, D.C., 1973.

The term “unit” refers to a unit operation. When more than one “unit” is described as being present, those units are operated in a parallel fashion. A single “unit”, however, may comprise more than one of the units in series, or in parallel, depending on the context. For example, an acid gas removal unit may comprise a hydrogen sulfide removal unit followed in series by a carbon dioxide removal unit. As another example, a trace contaminant removal unit may comprise a first removal unit for a first trace contaminant followed in series by a second removal unit for a second trace contaminant. As yet another example, a methane compressor unit may comprise a first methane compressor to compress a methane product stream to a first pressure, followed in series by a second methane compressor to further compress the methane product stream to a second (higher) pressure.

The term “syngas demand” refers to the maintenance of syngas balance in the hydromethanation reactor. As discussed above, in the overall desirable steady-state hydromethanation reaction (see equations (I), (II) and (III) above), hydrogen and carbon monoxide are generated and consumed in balance. Because both hydrogen and carbon monoxide are withdrawn as part of the gaseous products, hydrogen and carbon monoxide must be added to (and/or optionally separately generated in situ via a combustion/oxidation reaction with supplied oxygen) the hydromethanation reactor in an amount at least required to maintain this reaction balance. For the purposes of the present invention, the amount of hydrogen and carbon monoxide that must be added to the hydromethanation reactor is the “syngas demand” (excluding separate in situ syngas generation).

The term “steam demand” refers to the amount of steam that must be added to the hydromethanation reactor. Steam is consumed in the hydromethanation reaction and must be added to the hydromethanation reactor. The theoretical consumption of steam is two moles for every two moles of carbon in the feed to produce one mole of methane and one mole of carbon dioxide (see equation (V)). In actual practice, the steam consumption is not perfectly efficient and steam is withdrawn with the product gases; therefore, a greater than theoretical amount of steam needs to be added to the hydromethanation reactor, which amount is the “steam demand”. Steam can be added, for example, via the steam stream, steam in the feed gas stream, steam in the first oxygen-rich gas stream (if present), and steam generated in situ from any moisture content of the carbonaceous feedstock. The amount of steam to be added (and the source) is discussed in further detail below. It should be noted that any steam that is generated in situ or that is fed into the hydromethanation reactor at a temperature lower than the hydromethanation reaction temperature will have an impact on the “heat demand” for the hydromethanation reaction.

The term “heat demand” refers to the amount of heat energy that must be added to the hydromethanation reactor to keep the reaction of step (b) in thermal balance, as discussed above and as further detailed below.

The materials, methods, and examples herein are illustrative only and, except as specifically stated, are not intended to be limiting.

### General Process Information

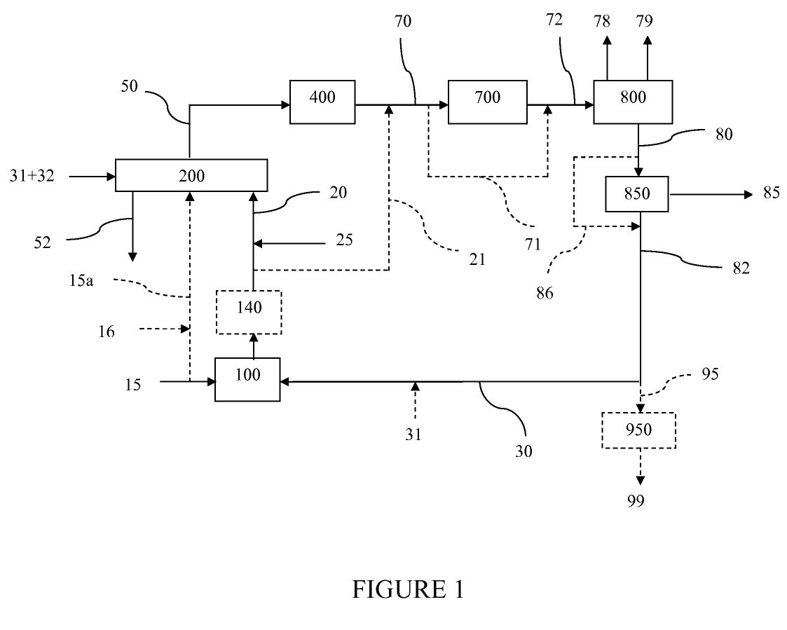

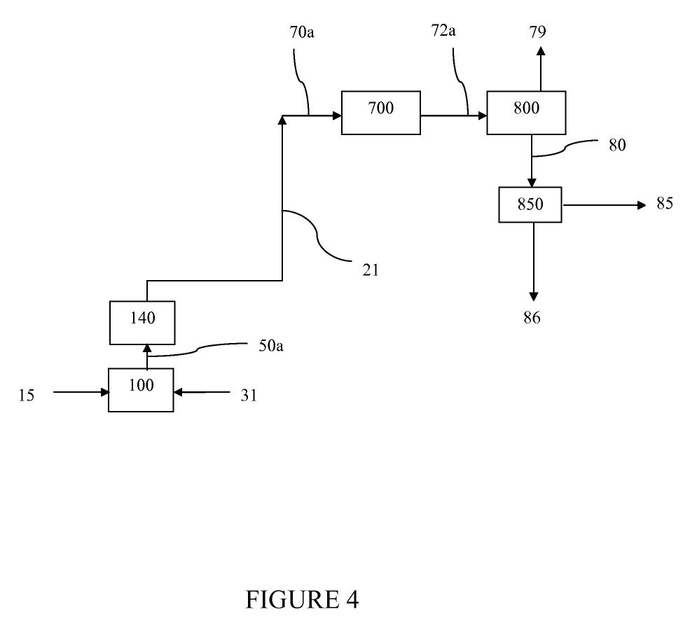

In one embodiment of the invention, a hydrogen product stream (85) can be generated from a carbonaceous feedstock as illustrated in FIGS. 1-3, which is the “hydromethanation portion” of the process of the present invention. The present invention also includes a backup hydrogen production process, as illustrated in FIG. 4, in the event that the hydromethanation portion is not operating.

First Hydrogen Production Mode

Referring to FIG. 1, a carbonaceous feedstock (32), a hydromethanation catalyst (31), a feed gas stream (20) comprising carbon monoxide, hydrogen and steam, and a steam stream (25), are provided to a hydromethanation reactor (200). An oxygen-rich gas stream (15a) (such as purified oxygen, optionally mixed with steam (16)) can optionally be fed to the hydromethanation reactor (200) as well. The carbonaceous feedstock, carbon monoxide, hydrogen, steam and optional oxygen are reacted in the hydromethanation reactor (200) in the presence of a hydromethanation catalyst, and under suitable pressure and temperature conditions, to form a methane-enriched raw product stream (50) comprising methane, hydrogen and a plurality of other gaseous products typically including carbon dioxide and carbon monoxide, as well as steam and certain contaminants (such as hydrogen sulfide and ammonia) primarily depending on the particular feedstock utilized. A char by-product (52) is also typically formed, and periodically or continuously withdrawn from hydromethanation reactor (200).

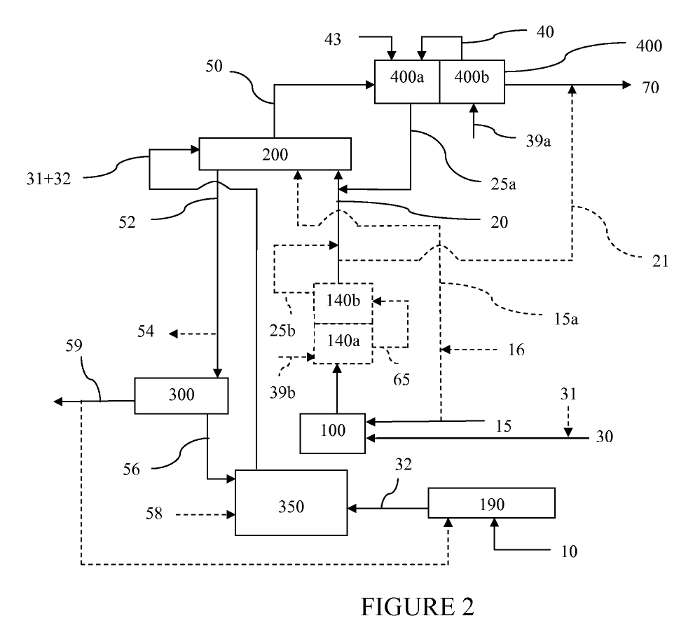

As illustrated in FIG. 2, the carbonaceous feedstock (32) is derived from one or more carbonaceous materials (10), which are processed in a feedstock preparation section (190) as discussed below.

The hydromethanation catalyst (31) can comprise one or more catalyst species, as discussed below.

The carbonaceous feedstock (32) and the hydromethanation catalyst (31) can be intimately mixed (i.e., to provide a catalyzed carbonaceous feedstock) before provision to the hydromethanation reactor (200), as discussed below.

As shown in FIG. 1, the feed gas stream (20) is generated in a partial oxidation (POx) reactor (100) from the partial oxidation of a recycle gas stream (sometimes also referred to as a hydrogen-depleted sweetened gas stream) (30) and an optional supplemental methane gas stream (31) as discussed below. The recycle gas stream (30) comprises predominantly methane, and optionally carbon monoxide and/or hydrogen, depending on the processing of the methane-enriched raw product gas stream (50) as discussed below. The supplemental methane gas stream (31) can range from substantially methane to a methane-containing stream such as a pipeline quality natural gas. A second oxygen-rich stream (15) is fed to the POx reactor (100), and the resulting POx reaction generates at least carbon monoxide, hydrogen and some steam, so the feed gas stream (20) predominantly comprises carbon monoxide, hydrogen and steam, and optionally smaller amounts of other gaseous components (such as carbon dioxide). Steam may be added to the feed gas stream (20), for example via steam stream (25) (for example, via steam streams (25a) and (25b) (FIG. 2)), as required to satisfy the steam demand of the hydromethanation reaction, as discussed further below. The feed gas stream (20) as it exits POx reactor (100) may require cooling prior to feeding into hydromethanation reactor (200), which can be done via a first heat exchanger unit (140). The heat energy recovered in the first heat exchanger unit (140) can, for example, be used to generate process steam and superheat other process streams, as discussed further below.

The methane-enriched raw product stream (50) resulting from the hydromethanation reaction is withdrawn from the hydromethanation reactor (200) and then subject to a sour shift in a sour shift reactor (700) to increase the hydrogen content and generate a hydrogen-enriched raw product stream (72). Typically, prior to the sour shift reactor (700), the methane-enriched raw product stream (50) is first cooled in a second heat exchanger unit (400) to generate a cooled raw product stream (70), which is then fed to the sour shift reactor (700). The heat energy recovered in the second heat exchanger unit (400) can, for example, be used to generate process steam and superheat other process streams, as discussed further below.

If both the carbon monoxide and hydrogen produced in POx reactor (100) are in excess of the syngas demand of the hydromethanation reaction, as discussed below, a portion of the feed gas stream (20) may be split via bypass line (21) and combined with the cooled raw product gas stream (70) for feeding into the sour shift unit (700).

The hydrogen-enriched raw product stream (72) leaving sour shift reactor (700) is then treated to remove acid gases (CO₂ and H₂S) in an acid gas removal unit (800) to generate a sweetened gas stream (80) comprising methane, hydrogen and, optionally, carbon monoxide. A separate H₂S stream (78) and CO₂ stream (79) can be removed from the acid gas removal unit (800) for further processing/use as described below.

The sweetened gas stream (80) is fed to a hydrogen separation unit (850) to generate a hydrogen product stream (85) and a hydrogen-depleted sweetened gas stream (82). Desirably, a high-purity hydrogen product (about 99 mol % or greater) is produced.

The hydrogen-depleted sweetened gas stream (82) will typically substantially comprise methane, but may optionally contain other gases such as carbon monoxide and hydrogen depending on the operation of sour shift unit (700) and hydrogen separation unit (850). The hydrogen-depleted sweetened gas stream (82) as such may be used as recycle gas stream (30).

In some embodiments, the hydrogen-depleted gas stream (82) may be split to generate the recycle gas stream (30) and a methane-rich product gas stream (95). If the hydrogen-depleted gas stream (82) contains carbon monoxide, it may be further purified/treated in, for example, a trim methanation unit (950) to generate a methane-enriched product gas stream (97). If desired, the carbon monoxide content of the hydrogen-depleted gas stream (82) can be increased for additional methane production (at the expense of hydrogen production) via the use of sour shift bypass line (71) which bypasses a portion of the cooled methane-enriched raw product stream (70) around sour shift unit (700) to preserve the carbon monoxide content (which might otherwise be consumed).

If the hydrogen content of the hydrogen-depleted gas stream (82) is insufficient to react with substantially all of the carbon monoxide present in the hydrogen-depleted gas stream (82), a portion of the sweetened gas stream (80) (which contains hydrogen) may be withdrawn via bypass line (86) and combined with the hydrogen-depleted sweetened gas stream (82) to provide the necessary hydrogen. A portion of the hydrogen product stream (85) may also be used for such purpose.

The optional methane product steam (99) can, for example, ultimately be methane-rich product gas stream (95) and/or methane-enriched product gas stream (97).

One desirable type of methane product stream is a pipeline-quality natural gas as described further below.

Other optional gas processing steps may occur before and/or after the acid gas removal unit (800).

The steam stream (25) fed to the hydromethanation reactor (200) is desirably derived from steam generated and superheated through one or more process heat recovery operations, for example, from one or more of heat exchangers (140), (400), (401) and (403) as shown in FIGS. 1-3.

The result is a hydromethanation process which produces a hydrogen product stream and optionally a methane product stream, and which can in steady-state operation be at least self-sufficient and integrated for steam, heat and syngas, as discussed further below.

Second Hydrogen Production Mode

When the first hydrogen production mode is not operating, the second hydrogen production mode can be implemented to continue hydrogen production with substantial interruption (other than for shut down of the hydromethanation portion and alteration of the process to implement the second hydromethanation production mode).

As shown in FIG. 4, in the second hydrogen production mode the supplemental methane gas stream (31) and second oxygen-rich gas stream (15) are fed to POx reactor (100). The methane (and other hydrocarbons) react with oxygen (partial oxidation/combustion) to generate the supplemental gas stream (50a), which comprises heat energy and carbon monoxide, hydrogen, and some steam, and optionally smaller amounts of other gaseous components (such as carbon dioxide) as discussed above.

In order to reduce the temperature of supplemental gas stream (50a) for downstream processing, supplemental gas stream is passed through a heat exchanger unit, such as first heat exchanger unit (140) to generate a cooled supplemental gas stream (70a). The heat energy recovered in first heat exchanger unit (140) can be used to generate process steam for use in other portions of the process or, for example, for supplemental power generation.

The cooled supplemental gas stream (70a) is then passed to a sour shift unit, such as sour shift unit (700), for example, via bypass line (21).

In sour shift unit (700), a substantial portion of the carbon monoxide from cooled supplemental gas stream (50a) is sour shifted to CO₂ to generate a hydrogen-enriched supplemental gas stream (72a) substantially comprising hydrogen and carbon dioxide (on a dry basis).

The hydrogen-enriched supplemental gas stream (72a) is then passed to an acid gas removal unit, such as acid gas removal unit (800), to remove a substantial portion of the carbon dioxide, leaving a sweetened gas stream (80) comprising substantially hydrogen with potentially minor amounts of other gases. The sweetened gas steam (80) is then purified, for example, in hydrogen separation unit (850) to produce the hydrogen product stream (85) and a tail gas stream (86). If there are combustible gases in the tail stream (86) (such as hydrogen and/or carbon monoxide), those can be burned to generate steam, heat energy and/or power for other operations.

### Hydromethanation Reactor/Reaction

Any of several types of gasification reactors can be utilized for the hydromethanation reactor (200). Suitable reactors include those having a reaction chamber which is a counter-current fixed bed, a co-current fixed bed, a fluidized bed, or an entrained flow or moving bed reaction chamber.

The hydromethanation reactor (200) is typically a fluidized-bed reactor. The hydromethanation reactor (200) can, for example, be a “flow down” countercurrent configuration, where the carbonaceous feedstock (32) is introduced at a higher point so that the particles flow down the fluidized bed to a char by-product collection zone, and the gases flow in an upward direction and are removed at a point above the fluidized bed. Alternatively, the hydromethanation reactor (200) can be a “flow up” co-current configuration, where the carbonaceous feedstock (32) is fed at a lower point so that the particles flow up the fluidized bed, along with the gases, to a char by-product collection zone. Typically, in a “flow up” configuration, there will also be a collection zone at the bottom of the reactor for larger particles (including char) which are not fluidized.

Step (b) occurs within the hydromethanation reactor (200).

When an oxygen-rich gas stream (15a) is also fed into the hydromethanation reactor (200), a portion of the carbon content from the carbonaceous feedstock can also be consumed in an oxidation/combustion reaction, generating heat energy as well as carbon monoxide and hydrogen. The hydromethanation and oxidation/combustion reactions may occur contemporaneously. Depending on the configuration of the hydromethanation reactor (200), as discussed below, the two steps may occur within the same area in the reactor, or may predominant in one zone. For example, when the oxygen-rich gas stream (15a) is fed into an area of the hydromethanation reactor (200) where char by-product collects, such as below an active hydromethanation fluidized bed zone, the hydromethanation reaction will predominate in the hydromethanation fluidized bed zone, and a partial oxidation/combustion reaction will predominate in the char by-product collection area.

The hydromethanation reactor (200) is typically operated at moderately high pressures and temperatures, requiring introduction of the appropriate carbonaceous feedstock to a reaction chamber of the reactor while maintaining the required temperature, pressure and flow rate of the feedstock. Those skilled in the art are familiar with feed inlets to supply the carbonaceous feedstock into the reaction chambers having high pressure and/or temperature environments, including star feeders, screw feeders, rotary pistons and lock-hoppers. It should be understood that the feed inlets can include two or more pressure-balanced elements, such as lock hoppers, which would be used alternately. In some instances, the carbonaceous feedstock can be prepared at pressure conditions above the operating pressure of the reactor and, hence, the particulate composition can be directly passed into the reactor without further pressurization.

The hydromethanation reactor (200) is desirably operated at a moderate temperature of at least about 700° F. (about 371° C.), or of at least about 800° F. (about 427° C.), or of at least about 900° F. (about 482° C.), to about 1500° F. (about 816° C.), or to about 1400° F. (about 760° C.), or to about 1300° F. (704° C.); and a pressures of about 250 psig (about 1825 kPa, absolute), or about 400 psig (about 2860 kPa), or about 450 psig (about 3204 kPa), or about 500 psig (about 3549 kPa), to about 800 psig (about 5617 kPa), or to about 700 psig (about 4928 kPa), or to about 600 psig (about 4238 kPa).

Typical gas flow velocities in the hydromethanation reactor (200) are from about 0.5 ft/sec (about 0.15 m/sec), or from about 1 ft/sec (about 0.3 m/sec), to about 2.0 ft/sec (about 0.6 m/sec), or to about 1.5 ft/sec (about 0.45 m/sec).

The hydromethanation reaction has a steam demand, a heat demand and a syngas demand. These conditions in combination are important factors in determining the operating conditions for the hydromethanation reaction as well as the remainder of the process.

For example, the steam demand of the hydromethanation reaction requires a molar ratio of steam to carbon (in the feedstock) of at least about 1. Typically, however, the molar ratio is greater than about 1, or from about 1.5 (or greater), to about 6 (or less), or to about 5 (or less), or to about 4 (or less), or to about 3 (or less), or to about 2 (or less). The moisture content of the carbonaceous feedstock (32), and steam included in the feed gas stream (20) and enriched-oxygen gas stream (15a) (if present), will determine the amount of steam steam (25) added to the hydromethanation reactor (200). In one embodiment of the present invention, the steam demand of the hydromethanation reaction is satisfied by steam stream (25), taking into account the moisture content of the carbonaceous feedstock (32) and steam included in the feed gas stream (20) and first oxygen-rich gas stream (15a) (if present) (FIG. 2).

As also indicated above, the hydromethanation reaction is essentially thermally balanced but, due to process heat losses and other energy requirements (for example, vaporization of moisture on the feedstock), some heat must be supplied to the hydromethanation reaction to maintain the thermal balance (the heat demand). The addition of the steam stream (25) and feed gas stream (20), plus the optional partial combustion/oxidation of carbon (from the carbonaceous feedstock) in the presence of the oxygen introduced into the hydromethanation reactor (200) from first oxygen-rich gas stream (15a), should be sufficient to satisfy the heat demand of the hydromethanation reaction.

When utilized, the oxygen-rich gas stream (15a) can be fed into the hydromethanation reactor (200) by any suitable means such as direct injection of purified oxygen, oxygen-air mixtures, oxygen-steam mixtures, or oxygen-inert gas mixtures into the reactor. See, for instance, U.S. Pat. No. 4,315,753 and Chiaramonte et al., Hydrocarbon Processing, September 1982, pp. 255-257. The oxygen-rich gas stream (15a) is typically generated via standard air-separation technologies, and is typically fed as a high-purity oxygen stream (about 95% or greater volume percent oxygen, dry basis).

When provided, the oxygen-rich gas stream (15a) will typically be provided as a mixture with a steam stream (16), and introduced at a temperature of from about 400° F. (about 204° C.), or from about 450° F. (about 232° C.), or from about 500° F. (about 260° C.), to about 750° F. (about 399° C.), or to about 700° F. (about 371° C.), or to about 650° F. (about 343° C.), and at a pressure at least slightly higher than present in the hydromethanation reactor (200).

The oxygen-rich gas stream (15a) can also be introduced as an admixture with the steam stream (25).

When provided, the oxygen-rich gas stream (15a) is typically introduced at a point below the fluidized bed zone of hydromethanation reactor (200) in order to avoid formation of hot spots in the reactor, and to avoid combustion of the gaseous products. The oxygen-rich gas stream (15a) can, for example, advantageously be introduced into an area of the hydromethanation reactor (200) where by-product char is collected, typically in the bottom of the reactor, so that carbon in the by-product char is preferentially consumed as opposed to carbon in a more active hydromethanation zone.

The variation of the amount of oxygen supplied to hydromethanation reactor (200) provides an advantageous process control. Increasing the amount of oxygen will increase the oxidation/combustion, and therefore increase in situ heat generation. Decreasing the amount of oxygen will conversely decrease the in situ heat generation.

The gas utilized in the hydromethanation reactor (200) for pressurization and reaction of the carbonaceous feedstock (32) comprises the steam stream (25), in combination with the feed gas stream (20) and, optionally, additional steam, nitrogen, air, or inert gases such as argon, which can be supplied to the hydromethanation reactor (200) according to methods known to those skilled in the art (such as discussed above for oxygen-rich gas stream (15a)). As a consequence, the steam stream (25) and feed gas stream (20) must be provided at a higher pressure which allows them to enter the hydromethanation reactor (200).

The temperature in the hydromethanation reactor (200) can be controlled, for example, by controlling the amount and temperature of steam stream (25) and feed gas stream (20), as well as the amount of optional oxygen (as discussed above), supplied to hydromethanation reactor (200).

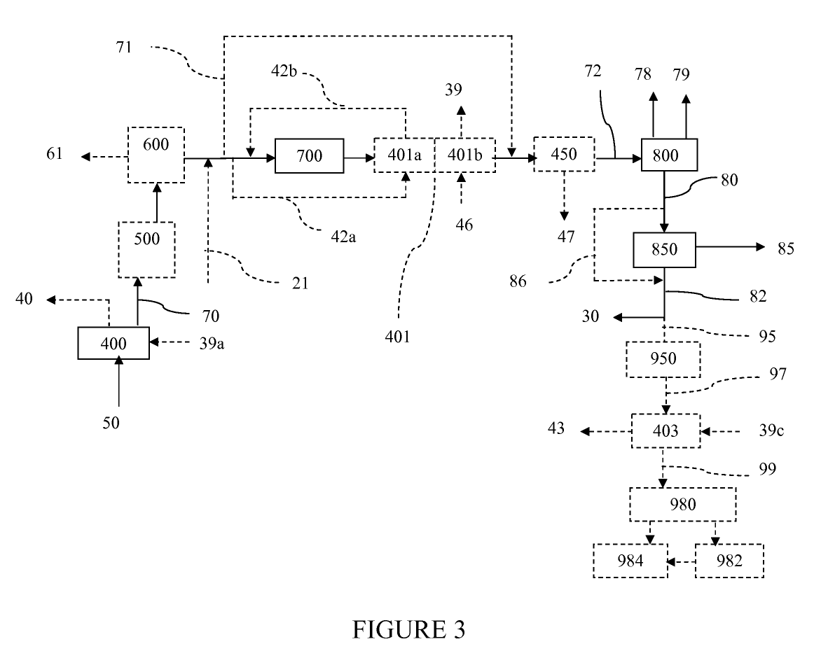

Advantageously, steam for the hydromethanation reaction is generated from other process operations through process heat capture (such as generated in a waste heat boiler, generally referred to as “process steam” or “process-generated steam”) and, in some embodiments, is solely supplied as process-generated steam. For example, process steam streams (such as (25a), (25b) and (43)) generated by a heat exchanger unit or waste heat boiler (such as, for example, (140a) and (400b) in FIG. 2, and/or (403) in FIGS. 2 and 3) can be fed to the hydromethanation reactor (200).

In certain embodiments, the overall process described herein for the generation of the hydrogen product stream (85) is substantially steam neutral, such that steam demand (pressure and amount) for the hydromethanation reaction can be satisfied via heat exchange with process heat at the different stages therein, or steam positive, such that excess steam is produced and can be used, for example, for power generation. Desirably, process-generated steam accounts for greater than about 95 wt %, or greater than about 97 wt %, or greater than about 99 wt %, or about 100 wt % or greater, of the steam demand of the hydromethanation reaction.

The result of the hydromethanation reaction is a methane-enriched raw product stream (50) typically comprising CH₄, CO₂, H₂, CO, H₂S, unreacted steam, entrained fines and, optionally, other contaminants such as NH₃, COS, HCN and/or elemental mercury vapor, depending on the nature of the carbonaceous material utilized for hydromethanation.

If the hydromethanation reaction is run in syngas balance, the methane-enriched raw product stream (50), upon exiting the hydromethanation reactor (200), will typically comprise at least about 20 mol %, or at least about 25 mol %, or at least about 27 mol %, methane based on the moles of methane, carbon dioxide, carbon monoxide and hydrogen in the methane-enriched raw product stream (50). In addition, the methane-enriched raw product stream (50) will typically comprise at least about 50 mol % methane plus carbon dioxide, based on the moles of methane, carbon dioxide, carbon monoxide and hydrogen in the methane-enriched raw product stream (50).

If the feed gas stream (20) contains an excess of carbon monoxide and/or hydrogen above and beyond the syngas demand, then there may be some dilution effect on the molar percent of methane and carbon dioxide in the methane-enriched raw product stream. Typically, however, excess syngas production from the POx reactor (100) will be split off from the feed gas stream (20) via bypass line (21) and fed to the sour shift reactor (700) (bypassing the hydromethanation reactor (200)) as discussed below.

### POx Reactor (100)

The POx reactor (100) is utilized in both the first and second hydrogen production modes.

POx reactors potentially suitable for use in conjunction with the present invention are, in a general sense, known to those of ordinary skill in the relevant art and include, for example, those based on technologies available from Royal Dutch Shell plc, Siemens AG, General Electric Company, Lurgi AG, Haldor Topsoe A/S, Uhde AG, KBR Inc. and others. Both catalytic and non-catalytic POx reactors are suitable for use in the present invention. In one embodiment, the POx reactor is non-catalytic (thermal). In another embodiment, the POx reactor is catalytic (autothermal reformer).

In the first hydrogen production mode, a recycle gas stream (30), a second oxygen-rich gas stream (15) and an optional supplemental methane gas stream (31) are fed to the POx reactor (100) and reacted. In the second hydrogen production mode, the second oxygen-rich gas stream (15) and supplemental methane gas stream (31) are fed to the POx reactor (100) and reacted. The oxidation reaction is exothermic and, thus, the resulting feed gas stream (20) (or supplemental gas steam (50a)) is produced at an elevated temperature and pressure. Typical operating temperatures range from about 1800° F. (about 982° C.), or from about 2000° F. (about 1093° C.), or from about 2200° F. (about 1204° C.), to about 2800° F. (about 1538° C.), or to about 2500° F. (about 1371° C.), or to about 2300° F. (about 1260° C.). In the first hydrogen production mode, the POx reactor (100) is typically operated at a temperature of at least about 250° F. (at least about 139° C.), or at least about 350° F. (at least about 194° C.), or at least about 450° F. (at least about 250° C.), or at least about 500° F. (at least about 278° C.), higher than the hydromethanation reactor (200).

Typical operating pressures range from about 400 psig (about 2860 kPa), or from about 500 psig (about 3549 kPa), or from about 550 psig (about 3894 kPa), to about 900 psig (about 6307 kPa), or to about 800 psig (about 5617 kPa), or to about 700 psig (about 4928 kPa), or to about 650 psig (about 4583 kPa). Operating at such pressures may require compression of the recycle gas stream (30) and/or supplemental methane gas stream (31) prior to introduction into the POx reactor (100). In the first hydrogen production mode, the POx reactor (100) is also operated at a higher pressure than the hydromethanation reactor (200) so that the feed gas stream (20) can be fed to the hydromethanation reactor (200) without additional pressurization, even with intermediate processing. Typically, the pressure in the POx reactor (100) will be at least about 50 psi (about 345 kPa), or at least about 100 psi (about 690 kPa), higher than the pressure in the hydromethanation reactor (200).

The POx reaction generates carbon monoxide and hydrogen, and smaller amounts of steam and other gases, from methane in the recycle gas stream (30) and optional supplemental methane gas stream (31) (and other hydrocarbons that may be present). The thermal (non-catalytic) POx reaction typically results in hydrogen to carbon monoxide molar ratios of from about 1.6 to about 1.8. A catalytic POx reaction (autothermal reformer) may result in a higher hydrogen to carbon monoxide ratio of from about 1.6 to about 2.65. If hydrogen and/or carbon monoxide are present in the recycle gas stream (30), this may alter the ratio slightly.

The feed gas stream (20) can be supplemented with additional hydrogen to raise the molar ratio, if desired, for example, from the hydrogen product stream (85), or through the use of bypass line (86).

In order to moderate the temperature of the feed gas stream (20) to a level suitable for feeding into hydromethanation reactor (200), the feed gas stream (20) can be mixed with steam, for example, steam stream (25) (to superheat steam stream (25)). Steam can also be fed directly into the POx reactor (100). Alternatively, or in conjunction with the above, the feed gas stream (20) can be passed through first heat exchanger unit (140) to remove heat energy prior to introduction into hydromethanation reactor (200). In one embodiment, as depicted in FIG. 2, first heat exchanger unit (140) comprises a steam boiler (140a) followed by a steam superheater (140b). A stream of boiler feed water (39b) can be passed through steam boiler (140a) to generate a first process steam stream (65), which is then passed through steam superheater (140b) to generate a superheated process steam stream (25b) of a suitable temperature and pressure for introduction into hydromethanation reactor (200), for example, by mixing with feed gas stream (20).

### Further Gas Processing

### Fines Removal

The hot gas effluent leaving the reaction chamber of the hydromethanation reactor (200) can pass through a fines remover unit (not pictured), incorporated into and/or external of the hydromethanation reactor (200), which serves as a disengagement zone. Particles too heavy to be entrained by the gas leaving the hydromethanation reactor (200) (i.e., fines) are returned to the hydromethanation reactor (200), for example, to the reaction chamber (e.g., fluidized bed).

Residual entrained fines may be substantially removed, when necessary, by any suitable device such as internal and/or external cyclone separators optionally followed by Venturi scrubbers. These recovered fines can be processed to recover alkali metal catalyst, or directly recycled back to feedstock preparation as described in previously incorporated US2009/0217589A1.

Removal of a “substantial portion” of fines means that an amount of fines is removed from the resulting gas stream such that downstream processing is not adversely affected; thus, at least a substantial portion of fines should be removed. Some minor level of ultrafine material may remain in the resulting gas stream to the extent that downstream processing is not significantly adversely affected. Typically, at least about 90 wt %, or at least about 95 wt %, or at least about 98 wt %, of the fines of a particle size greater than about 20 μm, or greater than about 10 μm, or greater than about 5 μm, are removed.

### Heat Exchange

In the first hydrogen production mode, depending on the hydromethanation conditions, the methane-enriched raw product stream (50) can be generated having at a temperature ranging from about 800° F. (about 427° C.) to about 1500° F. (about 816° C.), and more typically from about 1100° F. (about 593° C.) to about 1400° F. (about 760° C.), a pressure of from about 50 psig (about 446 kPa) to about 800 psig (about 5617 kPa), more typically from about 400 psig (about 2860 kPa) to about 600 psig (about 4238 kPa), and a velocity of from about 0.5 ft/sec (about 0.15 m/sec) to about 2.0 ft/sec (about 0.61 m/sec), more typically from about 1.0 ft/sec (0.30 m/sec) to about 1.5 ft/sec (about 0.46 m/sec).

The methane-enriched raw product stream (50) can be, for example, provided to a heat recovery unit, e.g., second heat exchanger unit (400) as shown in FIG. 1. Second heat exchanger unit (400) removes at least a portion of the heat energy from the methane-enriched raw product stream (50) and reduces the temperature of the methane-enriched raw product stream (50) to generate a cooled methane-enriched raw product stream (70) having a temperature less than the methane-enriched raw product stream (50). The heat energy recovered by second heat exchanger unit (400) can be used to generate a second process steam stream (40) of which at least a portion of the first process steam stream (40) can, for example, be fed back to the hydromethanation reactor (200).

In one embodiment, as depicted in FIG. 1, second heat exchanger unit (400) has both a steam boiler section (400b) preceded by a superheating section (400a). A stream of boiler feed water (39a) can be passed through steam boiler section (400b) to generate a first process steam stream (40), which is then passed through steam superheater (400a) to generate a superheated process steam stream (25a) of a suitable temperature and pressure for introduction into hydromethanation reactor (200), for example, by mixing with feed gas stream (20). Steam superheater (400a) can also be used to superheat other recycle steam streams (for example third process steam stream (43)) to the extent required for feeding into the hydromethanation reactor (200) as steam stream (25).

The resulting cooled methane-enriched raw product stream (70) will typically exit second heat exchanger unit (400) at a temperature ranging from about 450° F. (about 232° C.) to about 1100° F. (about 593° C.), more typically from about 550° F. (about 288° C.) to about 950° F. (about 510° C.), a pressure of from about 50 psig (about 446 kPa) to about 800 psig (about 5617 kPa), more typically from about 400 psig (about 2860 kPa) to about 600 psig (about 4238 kPa), and a velocity of from about 0.5 ft/sec (about 0.15 m/sec) to about 2.0 ft/sec (about 0.61 m/sec), more typically from about 1.0 ft/sec (0.30 m/sec) to about 1.5 ft/sec (about 0.46 m/sec).

In the second hydrogen production mode, as depicted in FIG. 4, the supplemental gas stream (50a) is typically cooled to a temperature suitable for feeding into sour shift unit (700). In such a case, supplemental gas stream (50a) can be passed through heat exchanger unit (140) (for example, steam boiler (140a)) to generate a process steam stream. The resulting cooled supplemental gas stream (70a) will typically exit first heat exchanger unit (140) at a temperature ranging from about 450° F. (about 232° C.) to about 1100° F. (about 593° C.), more typically from about 550° F. (about 288° C.) to about 950° F. (about 510° C.). Cooled supplemental gas stream (70a) will typically be passed directly to sour shift unit (700).

### Gas Purification

Product purification may comprise, for example, sour shift processes (700) and acid gas removal (800), and optional trace contaminant removal (500) and optional ammonia removal and recovery (600).

Trace Contaminant Removal (500)

As is familiar to those skilled in the art, the contamination levels of the gas stream, e.g., cooled methane-enriched raw product stream (70), will depend on the nature of the carbonaceous material used for preparing the carbonaceous feedstocks. For example, certain coals, such as Illinois #6, can have high sulfur contents, leading to higher COS contamination; and other coals, such as Powder River Basin coals, can contain significant levels of mercury which can be volatilized in hydromethanation reactor (200).

COS can be removed from a gas stream, e.g. the cooled methane-enriched raw product stream (70), by COS hydrolysis (see, U.S. Pat. No. 3,966,875, U.S. Pat. No. 4,011,066, U.S. Pat. No. 4,100,256, U.S. Pat. No. 4,482,529 and U.S. Pat. No. 4,524,050), passing the gas stream through particulate limestone (see, U.S. Pat. No. 4,173,465), an acidic buffered CuSO₄ solution (see, U.S. Pat. No. 4,298,584), an alkanolamine absorbent such as methyldiethanolamine, triethanolamine, dipropanolamine or diisopropanolamine, containing tetramethylene sulfone (sulfolane, see, U.S. Pat. No. 3,989,811); or counter-current washing of the cooled second gas stream with refrigerated liquid CO₂ (see, U.S. Pat. No. 4,270,937 and U.S. Pat. No. 4,609,388).

HCN can be removed from a gas stream, e.g., the cooled methane-enriched raw product stream (70), by reaction with ammonium sulfide or polysulfide to generate CO₂, H₂S and NH₃ (see, U.S. Pat. No. 4,497,784, U.S. Pat. No. 4,505,881 and U.S. Pat. No. 4,508,693), or a two stage wash with formaldehyde followed by ammonium or sodium polysulfide (see, U.S. Pat. No. 4,572,826), absorbed by water (see, U.S. Pat. No. 4,189,307), and/or decomposed by passing through alumina supported hydrolysis catalysts such as MoO₃, TiO₂ and/or ZrO₂ (see, U.S. Pat. No. 4,810,475, U.S. Pat. No. 5,660,807 and U.S. Pat. No. 5,968,465).

Elemental mercury can be removed from a gas stream, e.g., the cooled methane-enriched raw product stream (70), for example, by absorption by carbon activated with sulfuric acid (see, U.S. Pat. No. 3,876,393), absorption by carbon impregnated with sulfur (see, U.S. Pat. No. 4,491,609), absorption by a H₂S-containing amine solvent (see, U.S. Pat. No. 4,044,098), absorption by silver or gold impregnated zeolites (see, U.S. Pat. No. 4,892,567), oxidation to HgO with hydrogen peroxide and methanol (see, U.S. Pat. No. 5,670,122), oxidation with bromine or iodine containing compounds in the presence of SO₂ (see, U.S. Pat. No. 6,878,358), oxidation with a H, Cl and O— containing plasma (see, U.S. Pat. No. 6,969,494), and/or oxidation by a chlorine-containing oxidizing gas (e.g., ClO, see, U.S. Pat. No. 7,118,720).

When aqueous solutions are utilized for removal of any or all of COS, HCN and/or Hg, the waste water generated in the trace contaminants removal units can be directed to a waste water treatment unit (not depicted).

When present, a trace contaminant removal of a particular trace contaminant should remove at least a substantial portion (or substantially all) of that trace contaminant from the so-treated gas stream (e.g., cooled methane-enriched raw product stream (70)), typically to levels at or lower than the specification limits of the desired product stream. Typically, a trace contaminant removal should remove at least 90%, or at least 95%, or at least 98%, of COS, HCN and/or mercury from a cooled first gas stream, based on the weight of the contaminant in the prior to treatment.

Ammonia Removal and Recovery (600)

As is familiar to those skilled in the art, gasification of biomass, certain coals, certain petroleum cokes and/or utilizing air as an oxygen source for the hydromethanation reactor can produce significant quantities of ammonia in the product stream. Optionally, a gas stream, e.g. the cooled methane-enriched raw product stream (70) as depicted in FIG. 3, can be scrubbed by water in one or more ammonia removal and recovery units (600) to remove and recover ammonia.

The ammonia recovery treatment may be performed, for example, on the cooled methane-enriched raw product stream (70), directly from heat exchanger (400) or after treatment in one or both of (i) one or more of the trace contaminants removal units (500), and (ii) one or more sour shift units (700).

After scrubbing, the gas stream, e.g., the cooled methane-enriched raw product stream (70), will typically comprise at least H₂S, CO₂, CO, H₂ and CH₄. When the cooled methane-enriched raw product stream (70) has previously passed through a sour shift unit (700), then, after scrubbing, the gas stream will typically comprise at least H₂S, CO₂, H₂ and CH₄.

Ammonia can be recovered from the scrubber water according to methods known to those skilled in the art, can typically be recovered as an aqueous solution (61) (e.g., 20 wt %). The waste scrubber water can be forwarded to a waste water treatment unit (not depicted).

When present, an ammonia removal process should remove at least a substantial portion (and substantially all) of the ammonia from the scrubbed stream, e.g., the cooled methane-enriched raw product stream (70). “Substantial” removal in the context of ammonia removal means removal of a high enough percentage of the component such that a desired end product can be generated. Typically, an ammonia removal process will remove at least about 95%, or at least about 97%, of the ammonia content of a scrubbed first gas stream, based on the weight of ammonia in the stream prior to treatment.

Sour Shift (700)

In the first hydrogen production mode, a portion or all of the methane-enriched raw product stream (e.g., cooled methane-enriched raw product stream (70)) is supplied to a sour shift reactor (700). In the second hydrogen production mode, generally, substantially all of cooled supplemental gas stream (70a) is supplied to sour shift reactor (700).

In sour shift reactor (700), the gases undergo a sour shift reaction (also known as a water-gas shift reaction) in the presence of an aqueous medium (such as steam) to convert at least a predominant portion (or a substantial portion, or substantially all) of the CO to CO₂ and to increase the fraction of H₂ in order to produce a hydrogen-enriched raw product stream (72) (or hydrogen-enriched supplemental gas stream (72a)). The generation of increased hydrogen content is utilized to optimize the hydrogen product gas.

In the first hydrogen production mode, the water-gas shift treatment may be performed on the cooled methane-enriched raw product stream (70) passed directly from heat exchanger (400), or on the cooled methane-enriched raw product stream (70) that has passed through a trace contaminants removal unit (500) and/or an ammonia removal unit (600). In the second hydrogen production mode, the water-gas shift treatment may be performed on the cooled supplemental gas stream (70a) passed directly from heat exchanger (140).

A sour shift process is described in detail, for example, in U.S. Pat. No. 7,074,373. The process involves adding water, or using water contained in the gas, and reacting the resulting water-gas mixture adiabatically over a steam reforming catalyst. Typical steam reforming catalysts include one or more Group VIII metals on a heat-resistant support.

Methods and reactors for performing the sour gas shift reaction on a CO-containing gas stream are well known to those of skill in the art. Suitable reaction conditions and suitable reactors can vary depending on the amount of CO that must be depleted from the gas stream. In some embodiments, the sour gas shift can be performed in a single stage within a temperature range from about 100° C., or from about 150° C., or from about 200° C., to about 250° C., or to about 300° C., or to about 350° C. In these embodiments, the shift reaction can be catalyzed by any suitable catalyst known to those of skill in the art. Such catalysts include, but are not limited to, Fe₂O₃-based catalysts, such as Fe₂O₃—Cr₂O₃ catalysts, and other transition metal-based and transition metal oxide-based catalysts. In other embodiments, the sour gas shift can be performed in multiple stages. In one particular embodiment, the sour gas shift is performed in two stages. This two-stage process uses a high-temperature sequence followed by a low-temperature sequence. The gas temperature for the high-temperature shift reaction ranges from about 350° C. to about 1050° C. Typical high-temperature catalysts include, but are not limited to, iron oxide optionally combined with lesser amounts of chromium oxide. The gas temperature for the low-temperature shift ranges from about 150° C. to about 300° C., or from about 200° C. to about 250° C. Low-temperature shift catalysts include, but are not limited to, copper oxides that may be supported on zinc oxide or alumina. Suitable methods for the sour shift process are described in previously incorporated US2009/0246120A1.

The sour shift reaction is exothermic, so in both the first and second hydrogen production modes it is often carried out with a heat exchanger, such as fourth heat exchanger unit (401), to permit the efficient use of heat energy. Shift reactors employing these features are well known to those of skill in the art. An example of a suitable shift reactor is illustrated in previously incorporated U.S. Pat. No. 7,074,373, although other designs known to those of skill in the art are also effective.

In the first hydrogen production mode, following the sour gas shift procedure, the resulting hydrogen-enriched raw product stream (72) generally contains CH₄, CO₂, H₂, H₂₅, steam, optionally CO and optionally minor amounts of other contaminants. In the second hydrogen production mode, following the sour gas shift procedure, the resulting hydrogen-enriched supplemental gas stream (72a) generally contains H₂ and steam, optionally minor amount of CO and optionally minor amounts of other contaminants.

As indicated above, the hydrogen-enriched raw product stream (72) (or the hydrogen-enriched supplemental gas stream (72a)) can be provided to a heat recovery unit, e.g., fourth heat exchanger unit (401). While the fourth heat exchanger unit (401) is depicted in FIG. 3 as a separate unit, it can exist as such and/or be integrated into the sour shift reactor (700), thus being capable of cooling the sour shift reactor (700) and removing at least a portion of the heat energy from the hydrogen-enriched raw product stream (72) (or hydrogen-enriched supplemental gas stream (72a)) to reduce the temperature and generate a cooled stream.

At least a portion of the recovered heat energy can be used to generate a fourth process steam stream from a water/steam source.

In an alternative embodiment of the first hydrogen production mode, as depicted in FIG. 3, the hydrogen-enriched raw product stream (72), upon exiting sour shift reactor (700), is introduced into a superheater (401a) followed by a boiler feed water preheater (401b). Superheater (401a) can be used, for example, to superheat a stream (42a) which can be a portion of cooled methane-enriched raw product stream (70), to generate a superheated stream (42b) which is then recombined into cooled methane-enriched raw product stream (70). Alternatively, all of cooled methane-enriched product stream can be preheated in superheater (401a) and subsequently fed into sour shift reactor (700) as superheated stream (42b). Boiler feed water preheater (401b) can be used, for example, to preheat boiler feed water (46) to generate a preheated boiler water feed stream (39) for one or more of first heat exchanger unit (400), second heat exchanger unit (140) and third heat exchanger unit (403), as well as other steam generation operations.

In the first hydrogen production mode, if it is desired to retain some of the carbon monoxide content of the methane-enriched raw product stream (50), a gas bypass loop (71) in communication with the first heat recovery unit (400) can be provided to allow some of the cooled methane-enriched raw product stream (70) exiting the first heat recovery unit (400) to bypass the sour shift reactor (700) and the second heat recovery unit (e.g., fourth heat exchanger unit (401)) altogether, and be combined with hydrogen-enriched raw product stream (72) at some point prior to acid gas removal unit (800). This is particularly useful when it is desired to recover a separate methane by-product, as the retained carbon monoxide can be subsequently methanated as discussed below.

Acid Gas Removal (800)

In the first hydrogen production mode, a subsequent acid gas removal unit (800) is used to remove a substantial portion of H₂S and a substantial portion of CO₂ from the hydrogen-enriched treated product stream (72) and generate a sweetened gas stream (80). In the second hydrogen production mode, the acid gas removal unit (800) is used to remove a substantial portion of the CO₂ from the hydrogen-enriched supplemental gas stream (72a).

Acid gas removal processes typically involve contacting a gas stream with a solvent such as monoethanolamine, diethanolamine, methyldiethanolamine, diisopropylamine, diglycolamine, a solution of sodium salts of amino acids, methanol, hot potassium carbonate or the like to generate CO₂ and/or H₂S laden absorbers. One method can involve the use of Selexol® (UOP LLC, Des Plaines, Ill. USA) or Rectisol® (Lurgi AG, Frankfurt am Main, Germany) solvent having two trains; each train containing an H₂S absorber and a CO₂ absorber.

One method for removing acid gases is described in previously incorporated US2009/0220406A1.

At least a substantial portion (e.g., substantially all) of the CO₂ and/or H₂S (and other remaining trace contaminants) should be removed via the acid gas removal processes.

“Substantial” removal in the context of acid gas removal means removal of a high enough percentage of the component such that a desired end product can be generated. The actual amounts of removal may thus vary from component to component. For “pipeline-quality natural gas”, only trace amounts (at most) of H₂S can be present, although higher amounts of CO₂ may be tolerable.

Typically, at least about 85%, or at least about 90%, or at least about 92%, of the CO₂ should be removed from the hydrogen-enriched raw product stream (72) and the hydrogen-enriched supplemental gas stream (72a). Typically, at least about 95%, or at least about 98%, or at least about 99.5%, of the H₂S, should be removed from the hydrogen-enriched raw product stream (72).

Losses of desired product (hydrogen and/or methane) in the acid gas removal step should be minimized such that the sweetened gas stream (80) comprises at least a substantial portion (and substantially all) of the methane and hydrogen from the hydrogen-enriched raw product stream (72). Typically, such losses should be about 2 mol % or less, or about 1.5 mol % or less, or about 1 mol % of less, respectively, of the methane and hydrogen from the hydrogen-enriched raw product stream (72) (or the hydrogen-enriched supplemental gas stream (72a).

In the first hydrogen production mode, the resulting sweetened gas stream (80) will generally comprise CH₄, H₂ and optionally CO (for the downstream methanation), and typically small amounts of CO₂ and H₂O. In the second hydrogen production mode, the sweetened gas stream (80) will comprise substantially hydrogen with minor amounts of contaminants such as CO, CO₂ and H₂O.

Any recovered H₂S (78) from the acid gas removal (and other processes such as sour water stripping) can be converted to elemental sulfur by any method known to those skilled in the art, including the Claus process. Sulfur can be recovered as a molten liquid.

Any recovered CO₂ (79) from the acid gas removal can be compressed for transport in CO₂ pipelines, industrial use, and/or sequestration for storage or other processes such as enhanced oil recovery.

Prior to acid gas removal unit (800), the hydrogen-enriched raw product stream (72) (or the hydrogen enriched supplemental gas stream (72a) can be treated to reduced water content in via a knock-out drum or similar water separation device (450). A resulting waste water stream (47) (which will be a sour water stream in the first hydrogen production mode) can be sent to a wastewater treatment unit (not depicted) for further processing.

Hydrogen Separation (850)

Hydrogen may be separated from the sweetened product gas stream (80) according to methods known to those skilled in the art, such as cryogenic distillation, the use of molecular sieves, gas separation (e.g., ceramic) membranes, and/or pressure swing adsorption (PSA) techniques. See, for example, previously incorporated US2009/0259080A1.

In one embodiment, a PSA device is utilized for hydrogen separation. PSA technology for separation of hydrogen from gas mixtures containing methane (and optionally carbon monoxide) is in general well-known to those of ordinary skill in the relevant art as disclosed, for example, in U.S. Pat. No. 6,379,645 (and other citations referenced therein). PSA devices are generally commercially available, for example, based on technologies available from Air Products and Chemicals Inc. (Allentown, Pa.), UOP LLC (Des Plaines, Ill.) and others.

In another embodiment, a hydrogen membrane separator can be used followed by a PSA device.

In the first hydrogen production mode, such separation provides a high-purity hydrogen product stream (85) and a hydrogen-depleted sweetened gas stream (82). In the second hydrogen production mode, such separation provides a high-purity hydrogen product stream (85) and a tail gas stream (86).

The recovered hydrogen product stream (85) preferably has a purity of at least about 99 mole %, or at least 99.5 mole %, or at least about 99.9 mole %.

The hydrogen product stream (85) can be used, for example, as an energy source and/or as a reactant. For example, the hydrogen can be used as an energy source for hydrogen-based fuel cells, for power and/or steam generation (see 980, 982 and 984 in FIG. 3), and/or for a subsequent hydromethanation process. The hydrogen can also be used as a reactant in various hydrogenation processes, such as found in the chemical and petroleum refining industries.

The hydrogen-depleted sweetened gas stream (82) will comprise substantially methane, with optional minor amounts of carbon monoxide (depending primarily on the extent of the sour shift reaction and bypass), carbon dioxide (depending primarily on the effectiveness of the acid gas removal process) and hydrogen (depending primarily on the extent and effectiveness of the hydrogen separation technology), and is further processed/utilized as described below.

The tail gas stream (86) will typically comprise a low volume of combustible gases, such as hydrogen and carbon monoxide, and may be combusted for heat, power and/or steam generation.

Hydrogen-Depleted Sweetened Gas Stream (82)

The hydrogen-depleted sweetened gas stream (82) will comprise substantially methane, with optional minor amounts of hydrogen and carbon monoxide, and is used at least in part as the recycle gas stream (30) for feeding POx reactor (100). Hydrogen-depleted sweetened gas stream (82) may also be further processed and/or utilized as described below.

In one embodiment, in order to maximize hydrogen production, a substantial portion (or substantially all) of the hydrogen-depleted sweetened gas (82) is utilized as recycle gas stream (30). A minor portion (typically less than about 10 wt %) may be utilized for power generation, or for firing a superheater for feed gas stream (20) as discussed above.

If it is desired to produce a methane by-product stream (99), hydrogen-depleted sweetened gas stream (82) is split into recycle gas stream (30) as a predominant portion, and methane-rich product gas stream (95) as a minor portion. Typically, recycle gas stream (30) comprises at least about 60 wt % of hydrogen-depleted sweetened gas stream (82).

Depending on the operating pressure and temperature conditions, the recycle gas stream (30) will typically require compression prior to feeding into the PDX reactor (100).

Methanation (950)

All or a portion of methane-rich product gas stream (95) may be used directly as methane product stream (99), or all or a portion of methane-rich product gas stream (95) may be further processed/purified to produce methane product stream (99).

In one embodiment, the methane-rich product gas stream (95) is fed to a trim methanator (950) to generate additional methane from the carbon monoxide and hydrogen that may be present in methane-rich product gas stream (95), resulting in a methane-enriched product stream (97).

The methanation reaction can be carried out in any suitable reactor, e.g., a single-stage methanation reactor, a series of single-stage methanation reactors or a multistage reactor. Methanation reactors include, without limitation, fixed bed, moving bed or fluidized bed reactors. See, for instance, U.S. Pat. No. 3,958,957, U.S. Pat. No. 4,252,771, U.S. Pat. No. 3,996,014 and U.S. Pat. No. 4,235,044. Methanation reactors and catalysts are generally commercially available. The catalyst used in the methanation, and methanation conditions, are generally known to those of ordinary skill in the relevant art, and will depend, for example, on the temperature, pressure, flow rate and composition of the incoming gas stream.

As the methanation reaction is exothermic, in various embodiments the methane-enriched product gas stream (97) may be, for example, further provided to a heat recovery unit, e.g., third heat exchanger unit (403). While the heat exchanger (403) is depicted as a separate unit, it can exist as such and/or be integrated into methanator (950), thus being capable of cooling the methanator unit and removing at least a portion of the heat energy from the methane-enriched gas stream to reduce the temperature of the methane-enriched gas stream. The recovered heat energy can be utilized to generate a third process steam stream (43) from a water and/or steam source (39c).

Methane-enriched product gas stream (97) can be utilized as methane product stream (99) or, it can be further processed, when necessary, to separate and recover CH₄ by any suitable gas separation method known to those skilled in the art including, but not limited to, cryogenic distillation and the use of molecular sieves or gas separation (e.g., ceramic) membranes. Additional gas purification methods include, for example, the generation of methane hydrate as disclosed in previously incorporated US2009/0260287A1, US2009/0259080A1 and US2009/0246120A1.

Pipeline-Quality Natural Gas

The invention provides processes and systems that, in certain embodiments, are capable of generating “pipeline-quality natural gas” from the hydromethanation of carbonaceous materials. A “pipeline-quality natural gas” typically refers to a natural gas that is (1) within ±5% of the heating value of pure methane (whose heating value is 1010 btu/ft³ under standard atmospheric conditions), (2) substantially free of water (typically a dew point of about −40° C. or less), and (3) substantially free of toxic or corrosive contaminants. In some embodiments of the invention, the methane product stream (99) described in the above processes satisfies such requirements.

### Waste Water Treatment

Residual contaminants in waste water resulting from any one or more of the trace contaminant removal, sour shift, ammonia removal, acid gas removal and/or catalyst recovery processes can be removed in a waste water treatment unit to allow recycling of the recovered water within the plant and/or disposal of the water from the plant process according to any methods known to those skilled in the art. Depending on the feedstock and reaction conditions, such residual contaminants can comprise, for example, phenols, CO, CO₂, H₂S, COS, HCN, ammonia, and mercury. For example, H₂S and HCN can be removed by acidification of the waste water to a pH of about 3, treating the acidic waste water with an inert gas in a stripping column, and increasing the pH to about 10 and treating the waste water a second time with an inert gas to remove ammonia (see U.S. Pat. No. 5,236,557). H₂S can be removed by treating the waste water with an oxidant in the presence of residual coke particles to convert the H₂S to insoluble sulfates which may be removed by flotation or filtration (see U.S. Pat. No. 4,478,425). Phenols can be removed by contacting the waste water with a carbonaceous char containing mono- and divalent basic inorganic compounds (e.g., the solid char product or the depleted char after catalyst recovery, supra) and adjusting the pH (see U.S. Pat. No. 4,113,615). Phenols can also be removed by extraction with an organic solvent followed by treatment of the waste water in a stripping column (see U.S. Pat. No. 3,972,693, U.S. Pat. No. 4,025,423 and U.S. Pat. No. 4,162,902).

### Process Steam

A steam feed loop can be provided for feeding the various process steam streams (e.g., 40, 43 and 65) generated from heat energy recovery.

The process steam streams can be generated by contacting a water/steam source (such as (39a), (39b) and (39c)) with the heat energy recovered from the various process operations using one or more heat recovery units, such as heat exchangers (140), (400) and (403).

Any suitable heat recovery unit known in the art may be used. For example, a steam boiler or any other suitable steam generator (such as a shell/tube heat exchanger) that can utilize the recovered heat energy to generate steam can be used. The heat exchangers may also function as superheaters for steam streams, such as (400a) in FIG. 2, so that heat recovery through one of more stages of the process can be used to superheat the steam to a desired temperature and pressure, thus eliminating the need for separate fired superheaters.

While any water source can be used to generate steam, the water commonly used in known boiler systems is purified and deionized (about 0.3-1.0 μS/cm) so that corrosive processes are slowed.

In the context of the present process, the hydromethanation reaction will have a steam demand (temperature, pressure and volume), and the amount of process steam and process heat recovery can be sufficient to provide at least about 85 wt %, or at least about 90 wt %, or at least about 94 wt %, or at least about 97 wt %, or at least about 98 wt %, or at least about 99 wt %, of this total steam demand. The remaining about 15 wt % or less, or about 10 wt % or less, or about 6 wt % or less, or about 3 wt % or less, or about 2 wt % or less, or about 1 wt % or less, can be supplied by a make-up steam stream, which can be fed into the system as (or as a part of) steam stream (25).

A suitable steam boiler or steam generator can be used to provide the make-up steam stream. Such boilers can be powered, for example, through the use of any carbonaceous material such as powdered coal, biomass etc., and including but not limited to rejected carbonaceous materials from the feedstock preparation operations (e.g., fines, supra).

In another embodiment, the process steam stream or streams supply substantially all of the total steam demand for the hydromethanation reaction, in which there is substantially no make-up steam stream.

In another embodiment, an excess of process steam is generated. The excess steam can be used, for example, for power generation via a steam turbine, and/or drying the carbonaceous feedstock in a fluid bed drier to a desired reduced moisture content, as discussed below.

### Power Generation

A portion of the methane product stream (99) can be utilized for combustion (980) and steam generation (982), as can a portion of any recovered hydrogen (85). As indicated above, excess recycle steam may be provided to one or more power generators (984), such as a combustion or steam turbine, to produce electricity which may be either utilized within the plant or can be sold onto the power grid.

### Preparation of Carbonaceous Feedstocks

Carbonaceous materials processing (190)

Carbonaceous materials, such as biomass and non-biomass, can be prepared via crushing and/or grinding, either separately or together, according to any methods known in the art, such as impact crushing and wet or dry grinding to yield one or more carbonaceous particulates. Depending on the method utilized for crushing and/or grinding of the carbonaceous material sources, the resulting carbonaceous particulates may be sized (i.e., separated according to size) to provide the carbonaceous feedstock (32) for use in catalyst loading processes (350) to form a catalyzed carbonaceous feedstock (31+32) for the hydromethanation reactor (200).

Any method known to those skilled in the art can be used to size the particulates. For example, sizing can be performed by screening or passing the particulates through a screen or number of screens. Screening equipment can include grizzlies, bar screens, and wire mesh screens. Screens can be static or incorporate mechanisms to shake or vibrate the screen. Alternatively, classification can be used to separate the carbonaceous particulates. Classification equipment can include ore sorters, gas cyclones, hydrocyclones, rake classifiers, rotating trommels or fluidized classifiers. The carbonaceous materials can be also sized or classified prior to grinding and/or crushing.

The carbonaceous particulate can be supplied as a fine particulate having an average particle size of from about 25 microns, or from about 45 microns, up to about 2500 microns, or up to about 500 microns. One skilled in the art can readily determine the appropriate particle size for the carbonaceous particulates. For example, when a fluidized bed reactor is used, such carbonaceous particulates can have an average particle size which enables incipient fluidization of the carbonaceous materials at the gas velocity used in the fluidized bed reactor. Desirable particle size ranges for the hydromethanation reactor (200) are in the Geldart A and Geldart B ranges (including overlap between the two), depending on fluidization conditions, typically with limited amounts of fine (below about 25 microns) and coarse (greater than about 250 microns) material.

Additionally, certain carbonaceous materials, for example, corn stover and switchgrass, and industrial wastes, such as saw dust, either may not be amenable to crushing or grinding operations, or may not be suitable for use as such, for example due to ultra fine particle sizes. Such materials may be formed into pellets or briquettes of a suitable size for crushing or for direct use in, for example, a fluidized bed reactor. Generally, pellets can be prepared by compaction of one or more carbonaceous material; see for example, previously incorporated US2009/0218424A1. In other examples, a biomass material and a coal can be formed into briquettes as described in U.S. Pat. No. 4,249,471, U.S. Pat. No. 4,152,119 and U.S. Pat. No. 4,225,457. Such pellets or briquettes can be used interchangeably with the preceding carbonaceous particulates in the following discussions.

Additional feedstock processing steps may be necessary depending on the qualities of carbonaceous material sources. Biomass may contain high moisture contents, such as green plants and grasses, and may require drying prior to crushing. Municipal wastes and sewages also may contain high moisture contents which may be reduced, for example, by use of a press or roll mill (e.g., U.S. Pat. No. 4,436,028). Likewise, non-biomass, such as high-moisture coal, can require drying prior to crushing. Some caking coals can require partial oxidation to simplify operation. Non-biomass feedstocks deficient in ion-exchange sites, such as anthracites or petroleum cokes, can be pre-treated to create additional ion-exchange sites to facilitate catalyst loading and/or association. Such pre-treatments can be accomplished by any method known to the art that creates ion-exchange capable sites and/or enhances the porosity of the feedstock (see, for example, previously incorporated U.S. Pat. No. 4,468,231 and GB1599932). Oxidative pre-treatment can be accomplished using any oxidant known to the art.

The ratio and types of the carbonaceous materials in the carbonaceous particulates can be selected based on technical considerations, processing economics, availability, and proximity of the non-biomass and biomass sources. The availability and proximity of the sources for the carbonaceous materials can affect the price of the feeds, and thus the overall production costs of the catalytic gasification process. For example, the biomass and the non-biomass materials can be blended in at about 5:95, about 10:90, about 15:85, about 20:80, about 25:75, about 30:70, about 35:65, about 40:60, about 45:55, about 50:50, about 55:45, about 60:40, about 65:35, about 70:20, about 75:25, about 80:20, about 85:15, about 90:10, or about 95:5 by weight on a wet or dry basis, depending on the processing conditions.

Significantly, the carbonaceous material sources, as well as the ratio of the individual components of the carbonaceous particulates, for example, a biomass particulate and a non-biomass particulate, can be used to control other material characteristics of the carbonaceous particulates. Non-biomass materials, such as coals, and certain biomass materials, such as rice hulls, typically include significant quantities of inorganic matter including calcium, alumina and silica which form inorganic oxides (i.e., ash) in the catalytic gasifier. At temperatures above about 500° C. to about 600° C., potassium and other alkali metals can react with the alumina and silica in ash to form insoluble alkali aluminosilicates. In this form, the alkali metal is substantially water-insoluble and inactive as a catalyst. To prevent buildup of the residue in the hydromethanation reactor (200), a solid purge of by-product char (52) comprising ash, unreacted carbonaceous material, and various other compounds (such as alkali metal compounds, both water soluble and water insoluble) can be routinely withdrawn.

In preparing the carbonaceous particulates, the ash content of the various carbonaceous materials can be selected to be, for example, about 20 wt % or less, or about 15 wt % or less, or about 10 wt % or less, or about 5 wt % or less, depending on, for example, the ratio of the various carbonaceous materials and/or the starting ash in the various carbonaceous materials. In other embodiments, the resulting the carbonaceous particulates can comprise an ash content ranging from about 5 wt %, or from about 10 wt %, to about 20 wt %, or to about 15 wt %, based on the weight of the carbonaceous particulate. In other embodiments, the ash content of the carbonaceous particulate can comprise less than about 20 wt %, or less than about 15 wt %, or less than about 10 wt %, or less than about 8 wt %, or less than about 6 wt % alumina, based on the weight of the ash. In certain embodiments, the carbonaceous particulates can comprise an ash content of less than about 20 wt %, based on the weight of processed feedstock where the ash content of the carbonaceous particulate comprises less than about 20 wt % alumina, or less than about 15 wt % alumina, based on the weight of the ash.

Such lower alumina values in the carbonaceous particulates allow for, ultimately, decreased losses of catalysts, and particularly alkali metal catalysts, in the hydromethanation portion of the process. As indicated above, alumina can react with alkali source to yield an insoluble char comprising, for example, an alkali aluminate or aluminosilicate. Such insoluble char can lead to decreased catalyst recovery (i.e., increased catalyst loss), and thus, require additional costs of make-up catalyst in the overall process.

Additionally, the resulting carbonaceous particulates can have a significantly higher % carbon, and thus btu/lb value and methane product per unit weight of the carbonaceous particulate. In certain embodiments, the resulting carbonaceous particulates can have a carbon content ranging from about 75 wt %, or from about 80 wt %, or from about 85 wt %, or from about 90 wt %, up to about 95 wt %, based on the combined weight of the non-biomass and biomass.

In one example, a non-biomass and/or biomass is wet ground and sized (e.g., to a particle size distribution of from about 25 to about 2500 μm) and then drained of its free water (i.e., dewatered) to a wet cake consistency. Examples of suitable methods for the wet grinding, sizing, and dewatering are known to those skilled in the art; for example, see previously incorporated US2009/0048476A1. The filter cakes of the non-biomass and/or biomass particulates formed by the wet grinding in accordance with one embodiment of the present disclosure can have a moisture content ranging from about 40% to about 60%, or from about 40% to about 55%, or below 50%. It will be appreciated by one of ordinary skill in the art that the moisture content of dewatered wet ground carbonaceous materials depends on the particular type of carbonaceous materials, the particle size distribution, and the particular dewatering equipment used. Such filter cakes can be thermally treated, as described herein, to produce one or more reduced moisture carbonaceous particulates.

Each of the one or more carbonaceous particulates can have a unique composition, as described above. For example, two carbonaceous particulates can be utilized, where a first carbonaceous particulate comprises one or more biomass materials and the second carbonaceous particulate comprises one or more non-biomass materials. Alternatively, a single carbonaceous particulate comprising one or more carbonaceous materials utilized.

Catalyst Loading for Hydromethanation (350)

The hydromethanation catalyst is potentially active for catalyzing at least reactions (I), (II) and (III) described above. Such catalysts are in a general sense well known to those of ordinary skill in the relevant art and may include, for example, alkali metals, alkaline earth metals and transition metals, and compounds and complexes thereof. Typically, the hydromethanation catalyst is an alkali metal, such as disclosed in many of the previously incorporated references.

For the hydromethanation reaction, the one or more carbonaceous particulates are typically further processed to associate at least one hydromethanation catalyst, typically comprising a source of at least one alkali metal, to generate a catalyzed carbonaceous feedstock (31+32).

The carbonaceous particulate provided for catalyst loading can be either treated to form a catalyzed carbonaceous feedstock (31+32) which is passed to the hydromethanation reactor (200), or split into one or more processing streams, where at least one of the processing streams is associated with a hydromethanation catalyst to form at least one catalyst-treated feedstock stream. The remaining processing streams can be, for example, treated to associate a second component therewith. Additionally, the catalyst-treated feedstock stream can be treated a second time to associate a second component therewith. The second component can be, for example, a second hydromethanation catalyst, a co-catalyst, or other additive.

In one example, the primary hydromethanation catalyst can be provided to the single carbonaceous particulate (e.g., a potassium and/or sodium source), followed by a separate treatment to provide one or more co-catalysts and additives (e.g., a calcium source) to the same single carbonaceous particulate to yield the catalyzed carbonaceous feedstock (31+32). For example, see previously incorporated US2009/0217590A1 and US2009/0217586A1.

The hydromethanation catalyst and second component can also be provided as a mixture in a single treatment to the single second carbonaceous particulate to yield the catalyzed carbonaceous feedstock (31+32).

When one or more carbonaceous particulates are provided for catalyst loading, then at least one of the carbonaceous particulates is associated with a hydromethanation catalyst to form at least one catalyst-treated feedstock stream. Further, any of the carbonaceous particulates can be split into one or more processing streams as detailed above for association of a second or further component therewith. The resulting streams can be blended in any combination to provide the catalyzed carbonaceous feedstock (31+32), provided at least one catalyst-treated feedstock stream is utilized to form the catalyzed feedstock stream.

In one embodiment, at least one carbonaceous particulate is associated with a hydromethanation catalyst and optionally, a second component. In another embodiment, each carbonaceous particulate is associated with a hydromethanation catalyst and optionally, a second component.

Any methods known to those skilled in the art can be used to associate one or more hydromethanation catalysts with any of the carbonaceous particulates and/or processing streams. Such methods include but are not limited to, admixing with a solid catalyst source and impregnating the catalyst onto the processed carbonaceous material. Several impregnation methods known to those skilled in the art can be employed to incorporate the hydromethanation catalysts. These methods include but are not limited to, incipient wetness impregnation, evaporative impregnation, vacuum impregnation, dip impregnation, ion exchanging, and combinations of these methods.

In one embodiment, an alkali metal hydromethanation catalyst can be impregnated into one or more of the carbonaceous particulates and/or processing streams by slurrying with a solution (e.g., aqueous) of the catalyst in a loading tank. When slurried with a solution of the catalyst and/or co-catalyst, the resulting slurry can be dewatered to provide a catalyst-treated feedstock stream, again typically, as a wet cake. The catalyst solution can be prepared from any catalyst source in the present processes, including fresh or make-up catalyst and recycled catalyst or catalyst solution. Methods for dewatering the slurry to provide a wet cake of the catalyst-treated feedstock stream include filtration (gravity or vacuum), centrifugation, and a fluid press.

In another embodiment, as disclosed in previously incorporated US2010/0168495A1, the carbonaceous particulates are combined with an aqueous catalyst solution to generate a substantially non-draining wet cake, then mixed under elevated temperature conditions and finally dried to an appropriate moisture level.

One particular method suitable for combining a coal particulate and/or a processing stream comprising coal with a hydromethanation catalyst to provide a catalyst-treated feedstock stream is via ion exchange as described in previously incorporated US2009/0048476A1 and US2010/0168494A1. Catalyst loading by ion exchange mechanism can be maximized based on adsorption isotherms specifically developed for the coal, as discussed in the incorporated reference. Such loading provides a catalyst-treated feedstock stream as a wet cake. Additional catalyst retained on the ion-exchanged particulate wet cake, including inside the pores, can be controlled so that the total catalyst target value can be obtained in a controlled manner. The total amount of catalyst loaded can be controlled by controlling the concentration of catalyst components in the solution, as well as the contact time, temperature and method, as disclosed in the aforementioned incorporated references, and as can otherwise be readily determined by those of ordinary skill in the relevant art based on the characteristics of the starting coal.

In another example, one of the carbonaceous particulates and/or processing streams can be treated with the hydromethanation catalyst and a second processing stream can be treated with a second component (see previously incorporated US2007/0000177A1).

The carbonaceous particulates, processing streams, and/or catalyst-treated feedstock streams resulting from the preceding can be blended in any combination to provide the catalyzed second carbonaceous feedstock, provided at least one catalyst-treated feedstock stream is utilized to form the catalyzed carbonaceous feedstock (31+32). Ultimately, the catalyzed carbonaceous feedstock (31+32) is passed onto the hydromethanation reactor(s) (200).

Generally, each catalyst loading unit comprises at least one loading tank to contact one or more of the carbonaceous particulates and/or processing streams with a solution comprising at least one hydromethanation catalyst, to form one or more catalyst-treated feedstock streams. Alternatively, the catalytic component may be blended as a solid particulate into one or more carbonaceous particulates and/or processing streams to form one or more catalyst-treated feedstock streams.

Typically, when the hydromethanation catalyst is an alkali metal, it is present in the catalyzed carbonaceous feedstock in an amount sufficient to provide a ratio of alkali metal atoms to carbon atoms in the particulate composition ranging from about 0.01, or from about 0.02, or from about 0.03, or from about 0.04, to about 0.10, or to about 0.08, or to about 0.07, or to about 0.06.

With some feedstocks, the alkali metal component may also be provided within the catalyzed carbonaceous feedstock to achieve an alkali metal content of from about 3 to about 10 times more than the combined ash content of the carbonaceous material in the catalyzed carbonaceous feedstock, on a mass basis.

Suitable alkali metals are lithium, sodium, potassium, rubidium, cesium, and mixtures thereof. Particularly useful are potassium sources. Suitable alkali metal compounds include alkali metal carbonates, bicarbonates, formates, oxalates, amides, hydroxides, acetates, or similar compounds. For example, the catalyst can comprise one or more of sodium carbonate, potassium carbonate, rubidium carbonate, lithium carbonate, cesium carbonate, sodium hydroxide, potassium hydroxide, rubidium hydroxide or cesium hydroxide, and particularly, potassium carbonate and/or potassium hydroxide.

Optional co-catalysts or other catalyst additives may be utilized, such as those disclosed in the previously incorporated references.

The one or more catalyst-treated feedstock streams that are combined to form the catalyzed carbonaceous feedstock typically comprise greater than about 50%, greater than about 70%, or greater than about 85%, or greater than about 90% of the total amount of the loaded catalyst associated with the catalyzed carbonaceous feedstock (31+32). The percentage of total loaded catalyst that is associated with the various catalyst-treated feedstock streams can be determined according to methods known to those skilled in the art.

Separate carbonaceous particulates, catalyst-treated feedstock streams, and processing streams can be blended appropriately to control, for example, the total catalyst loading or other qualities of the catalyzed carbonaceous feedstock (31+32), as discussed previously. The appropriate ratios of the various stream that are combined will depend on the qualities of the carbonaceous materials comprising each as well as the desired properties of the catalyzed carbonaceous feedstock (31+32). For example, a biomass particulate stream and a catalyzed non-biomass particulate stream can be combined in such a ratio to yield a catalyzed carbonaceous feedstock (31+32) having a predetermined ash content, as discussed previously.

Any of the preceding catalyst-treated feedstock streams, processing streams, and processed feedstock streams, as one or more dry particulates and/or one or more wet cakes, can be combined by any methods known to those skilled in the art including, but not limited to, kneading, and vertical or horizontal mixers, for example, single or twin screw, ribbon, or drum mixers. The resulting catalyzed carbonaceous feedstock (31+32) can be stored for future use or transferred to one or more feed operations for introduction into the hydromethanation reactor(s). The catalyzed carbonaceous feedstock can be conveyed to storage or feed operations according to any methods known to those skilled in the art, for example, a screw conveyer or pneumatic transport.

Further, excess moisture can be removed from the catalyzed carbonaceous feedstock (31+32). For example, the catalyzed carbonaceous feedstock (31+32) may be dried with a fluid bed slurry drier (i.e., treatment with superheated steam to vaporize the liquid), or the solution thermally evaporated or removed under a vacuum, or under a flow of an inert gas, to provide a catalyzed carbonaceous feedstock having a residual moisture content, for example, of about 10 wt % or less, or of about 8 wt % or less, or about 6 wt % or less, or about 5 wt % or less, or about 4 wt % or less. In such a case, steam generated from process heat recovery is desirably utilized.

Catalyst Recovery (300)

Reaction of the catalyzed carbonaceous feedstock (31+32) under the described conditions generally provides the methane-enriched raw product stream (50) and a solid char by-product (52) from the hydromethanation reactor (200). The solid char by-product (52) typically comprises quantities of unreacted carbon, inorganic ash and entrained catalyst. The solid char by-product (52) can be removed from the hydromethanation reactor (200) for sampling, purging, and/or catalyst recovery via a char outlet.

The term “entrained catalyst” as used herein means chemical compounds comprising the catalytically active portion of the hydromethanation catalyst, such as an alkali metal component. For example, “entrained catalyst” can include, but is not limited to, soluble alkali metal compounds (such as alkali carbonates, alkali hydroxides, and alkali oxides) and/or insoluble alkali compounds (such as alkali aluminosilicates). The nature of catalyst components associated with the char extracted from a catalytic gasifier and methods for their recovery are discussed in detail in previously incorporated US2007/0277437A1, US2009/0165383A1, US2009/0165382A1, US2009/0169449A1 and US2009/0169448A1.

The solid char by-product (52) can be periodically withdrawn from the hydromethanation reactor (200) through a char outlet which is a lock hopper system, although other methods are known to those skilled in the art. Methods for removing solid char product are well known to those skilled in the art. One such method taught by EP-A-0102828, for example, can be employed.

The char by-product (52) from the hydromethanation reactor (200) may be passed to a catalytic recovery unit (300), as described below. Such char by-product (52) may also be split into multiple streams, one of which may be passed to a catalyst recovery unit (300), and another stream (54) which may be used, for example, as a methanation catalyst (as described in previously incorporated US2010/0121125A1) and not treated for catalyst recovery.

In certain embodiments, when the hydromethanation catalyst is an alkali metal, the alkali metal in the solid char by-product (52) can be recovered to produce a catalyst recycle stream (56), and any unrecovered catalyst can be compensated by a catalyst make-up stream (58). The more alumina plus silica that is in the feedstock, the more costly it is to obtain a higher alkali metal recovery.

In one embodiment, the solid char by-product (52) from the hydromethanation reactor (200) can be quenched with a recycle gas and water to extract a portion of the entrained catalyst. The recovered catalyst (56) can be directed to the catalyst loading unit (350) for reuse of the alkali metal catalyst. The depleted char (59) can, for example, be directed to any one or more of the feedstock preparation operations (190) for reuse in preparation of the catalyzed feedstock, combusted to power one or more steam generators (such as disclosed in previously incorporated US2009/0165376A1)), or used as such in a variety of applications, for example, as an absorbent (such as disclosed in previously incorporated US2009/0217582A1).

Other particularly useful recovery and recycling processes are described in U.S. Pat. No. 4,459,138, as well as previously incorporated US2007/0277437A1 US2009/0165383A1, US2009/0165382A1, US2009/0169449A1 and US2009/0169448A1. Reference can be had to those documents for further process details.

The recycle of catalyst can be to one or a combination of catalyst loading processes. For example, all of the recycled catalyst can be supplied to one catalyst loading process, while another process utilizes only makeup catalyst. The levels of recycled versus makeup catalyst can also be controlled on an individual basis among catalyst loading processes.

### Multi-Train Processes

In the processes of the invention, each process may be performed in one or more processing units. For example, one or more hydromethanation reactors may be supplied with the carbonaceous feedstock from one or more catalyst loading and/or feedstock preparation unit operations. Similarly, the methane-enriched raw product streams generated by one or more hydromethanation reactors may be processed or purified separately or via their combination at a heat exchanger, sour shift unit, acid gas removal unit, and/or hydrogen separator unit depending on the particular system configuration, as discussed, for example, in previously incorporated US2009/0324458A1, US2009/0324459A1, US2009/0324460A1, US2009/0324461A1 and US2009/0324462A1.

In certain embodiments, the processes utilize two or more hydromethanation reactors (e.g., 2-4 hydromethanation reactors). In such embodiments, the processes may contain divergent processing units (i.e., less than the total number of hydromethanation reactors) prior to the hydromethanation reactors for ultimately providing the catalyzed carbonaceous feedstock to the plurality of hydromethanation reactors, and/or convergent processing units (i.e., less than the total number of hydromethanation reactors) following the hydromethanation reactors for processing the plurality of methane-enriched raw product streams generated by the plurality of hydromethanation reactors.

For example, the processes may utilize (i) divergent catalyst loading units to provide the catalyzed carbonaceous feedstock to the hydromethanation reactors; (ii) divergent carbonaceous materials processing units to provide a carbonaceous particulate to the catalyst loading units; (iii) convergent heat exchangers to accept a plurality of methane-enriched raw product streams from the hydromethanation reactors; (iv) convergent sour shift reactors to accept a plurality of cooled methane-enriched raw product streams from the heat exchangers; (v) convergent acid gas removal units to accept a plurality of hydrogen-enriched raw product gas streams from the sour shift reactor; or (vi) convergent hydrogen separation units to accept a plurality of sweetened gas streams from acid gas removal units.

When the systems contain convergent processing units, each of the convergent processing units can be selected to have a capacity to accept greater than a 1/n portion of the total gas stream feeding the convergent processing units, where n is the number of convergent processing units. For example, in a process utilizing 4 hydromethanation reactors and 2 heat exchangers for accepting the 4 methane-enriched raw product streams from the hydromethanation reactors, the heat exchanges can be selected to have a capacity to accept greater than ½ of the total gas volume (e.g., ½ to ¾) of the 4 gas streams and be in communication with two or more of the hydromethanation reactors to allow for routine maintenance of the one or more of the heat exchangers without the need to shut down the entire processing system.

Similarly, when the systems contain divergent processing units, each of the divergent processing units can be selected to have a capacity to accept greater than a 1/m portion of the total feed stream supplying the convergent processing units, where m is the number of divergent processing units. For example, in a process utilizing 2 catalyst loading units and a single carbonaceous material processing unit for providing the carbonaceous particulate to the catalyst loading units, the catalyst loading units, each in communication with the carbonaceous material processing unit, can be selected to have a capacity to accept ½ to all of the total volume of carbonaceous particulate from the single carbonaceous material processing unit to allow for routine maintenance of one of the catalyst loading units without the need to shut down the entire processing system.

We claim:

1. A process for generating a hydrogen product stream, the process comprising a first hydrogen production mode and a second hydrogen production mode, wherein the second hydrogen production mode is utilized when the first hydrogen production mode is not operating, wherein the first hydrogen production mode comprises the steps of:
(a) supplying to a hydromethanation reactor (1) a carbonaceous feedstock, (2) a hydromethanation catalyst, (3) a steam stream, (4) a feed gas stream and (5) optionally a first oxygen-rich gas stream;
(b) reacting the carbonaceous feedstock in the hydromethanation reactor in the presence of carbon monoxide, hydrogen, steam, hydromethanation catalyst and optionally oxygen, to produce a methane-enriched raw product stream comprising methane, carbon monoxide, hydrogen, carbon dioxide, hydrogen sulfide and heat energy;
(c) withdrawing the methane-enriched raw product stream from the hydromethanation reactor;
(d) introducing the methane-enriched raw product stream into a first heat exchanger unit to remove heat energy from the methane-enriched raw product stream;
(e) sour shifting at least a predominant portion of the carbon monoxide in the methane-enriched raw product stream in a sour shift unit to produce a hydrogen-enriched raw product stream comprising hydrogen, methane, carbon dioxide, hydrogen sulfide and optionally carbon monoxide;
(f) removing a substantial portion of the carbon dioxide and a substantial portion of the hydrogen sulfide from the hydrogen-enriched raw product stream in an acid gas removal unit to produce a sweetened gas stream comprising a substantial portion of the hydrogen, methane and carbon monoxide (if present) from the hydrogen-enriched raw product stream;
(g) separating at least a predominant portion of the hydrogen from the sweetened gas stream in a hydrogen separation unit to produce (1) the hydrogen product stream and (2) a hydrogen-depleted sweetened gas stream comprising methane, carbon monoxide (if present in the sweetened gas stream) and optionally hydrogen;
(h) optionally splitting the hydrogen-depleted sweetened gas stream into a recycle gas stream and a methane-rich product gas stream;
(i) supplying at least a portion of the hydrogen-depleted sweetened gas stream (or the recycle gas stream if present), a second oxygen-rich gas stream and an optional supplemental methane gas stream to a partial oxidation reactor; and
(j) reacting the supplied hydrogen-depleted sweetened gas stream (or the supplied recycle gas stream if present) and the supplied supplemental methane gas stream (if present) with oxygen in the partial oxidation reactor to generate heat energy and the feed gas stream, wherein the feed gas steam comprises carbon monoxide, hydrogen and steam,
wherein the reaction in step (b) has a syngas demand, and the amount of the hydrogen-depleted sweetened gas stream (or the recycle gas stream if present) supplied to the partial oxidation reactor is at least sufficient to generate enough carbon monoxide and hydrogen in the feed gas stream to at least meet the syngas demand of the reaction in step (b); and
wherein the second hydrogen production mode comprises the steps of:
(1) supplying the supplemental methane gas stream and the second oxygen-rich gas stream to the partial oxidation reactor;
(2) reacting the supplied supplemental methane gas stream with oxygen in the partial oxidation reactor to generate heat energy and a supplemental gas stream comprising carbon monoxide, hydrogen and steam;
(3) introducing the supplemental gas stream into a heat exchanger unit to remove heat energy from the supplemental gas stream;
(4) sour shifting at least a substantial portion of the carbon monoxide in the supplemental gas stream in a sour shift unit to produce a hydrogen-enriched supplemental gas stream comprising hydrogen and carbon dioxide;
(5) removing a substantial portion of the carbon dioxide from the hydrogen-enriched supplemental gas stream in an acid gas removal unit to produce a hydrogen gas stream comprising a substantial portion of the hydrogen from the hydrogen-enriched supplemental gas stream; and
(6) purifying the hydrogen gas stream in a hydrogen separation unit to produce the hydrogen product stream.

2. The process of claim 1, wherein the partial oxidation reactor is a non-catalytic partial oxidation reactor.

3. The process of claim 1, wherein the partial oxidation reactor is a catalytic partial oxidation reactor.

4. The process of claim 1, wherein in the first hydrogen production mode step (h) is present.

5. The process of claim 1, wherein in the first hydrogen production mode step (h) is not pre-sent.

6. The process of claim 1, wherein in the first hydrogen production mode the reaction in step (b) has a steam demand; the carbonaceous feedstock optionally comprises a moisture con-tent; the first oxygen-rich gas stream, if present, optionally comprises steam; the steam demand is substantially satisfied by the steam stream, steam contained in the feed gas stream, the moisture content (if present) of the carbonaceous feedstock, and (if present) steam in the first oxygen-rich gas stream; in the first hydrogen production mode the reaction in step (b) has a heat demand; and the steam stream and the feed gas stream as fed into the hydromethanation reactor comprise heat energy that, in combination, is sufficient to at least meet the heat demand of the reaction in step (b).

7. The process of claim 1, wherein in the first hydrogen production mode the first oxygen-rich gas stream is supplied periodically or continuously to the hydromethanation reactor.

8. The process of claim 1, wherein in the first hydrogen production mode a char by-product is generated in step (b), the char by-product is periodically or continuously withdrawn from the hydromethanation reactor, and at least a portion of the withdrawn by-product char is provided to a catalyst recovery operation.

9. The process of claim 1, wherein in the first hydrogen production mode the heat energy removed in step (d) is used at least in part to generate process steam.

10. The process of claim 9, wherein in the first hydrogen production mode the feed gas stream is passed through a second heat exchanger unit to remove heat energy prior to introduction into the hydromethanation reactor.

11. The process of claim 10, wherein in the first hydrogen production mode the heat energy removed from the feed gas stream is used at least in part to generate process steam.

12. The process claim 11, wherein in the first hydrogen production mode the steam stream is substantially made up from process steam.

13. The process of claim 1, wherein in the first hydrogen production mode the recycle gas stream comprises from about 34 wt % up to about 60 wt % of the sweetened gas stream (or the hydrogen-depleted sweetened gas stream if present, or the methane-enriched sweetened gas stream if present, or the methane-enriched split gas feed stream if present).

14. The process of claim 1, wherein in the first hydrogen production mode the hydro-methanation catalyst comprises an alkali metal hydromethanation catalyst, the carbonaceous feedstock is loaded with a hydromethanation catalyst prior to introduction into the hydro-methanation reactor, and the carbonaceous feedstock is loaded with an amount of an alkali metal hydromethanation catalyst sufficient to provide a ratio of alkali metal atoms to carbon atoms ranging from about 0.01 to about 0.10.

15. The process of claim 1, wherein the heat exchanger unit used in the second hydrogen production mode is also used in the first hydrogen production mode.

16. The process of claim 1, wherein the sour shift unit used in the second hydrogen production mode is also used in the first hydrogen production mode.

17. The process of claim 1, wherein the acid gas removal unit used in the second hydrogen production mode is also used in the first hydrogen production mode.

18. The process of claim 1, wherein the hydrogen separation unit used in the second hydrogen production mode is also used in the first hydrogen production mode.

19. The process of claim 1, wherein the heat exchanger unit, sour shift unit, acid gas removal unit and hydrogen separation unit used in the second hydrogen production mode are also used in the first hydrogen production mode.

20. The process of claim 1, wherein when the first hydrogen production mode is operating, steps (a), (b), (c), (d), (e), (f), (g), (i), (j) and (k), and when present (h), are operated in a continuous manner, and when the second hydrogen production mode is operating, steps (1), (2), (3), (4), (5) and (6) are operated in a continuous manner.
